(19) United States
(12) Patent Application Publication
(10) Pub. No.: US 2026/0285074 A1
(43) Pub. Date: Sep. 24, 2026

(54) PRINTING APPARATUS AND ADJUSTMENT METHOD THEREFOR

(71) Applicant: SCREEN Holdings Co., Ltd., Kyoto (JP)

(72) Inventors: Kenichi YOKOUCHI, Kyoto-shi (JP); Keiji HATANO, Kyoto-shi (JP)

(21) Appl. No.: 19/562,414

(22) Filed: Mar. 10, 2026

(30) Foreign Application Priority Data
Mar. 24, 2025 (JP) 2025-048099

(51) Int. Cl. B41J 29/393; B41J 3/60

(52) U.S. Cl. CPC B41J 29/393; B41J 3/60

(57) ABSTRACT

The inkjet printing apparatus is configured to be able to execute a batch adjustment process of performing adjustment processes for a plurality of adjustment items related to printing. The batch adjustment process includes a front surface printing process, a front surface reading process, a front surface printing condition setting process, a back surface printing process, a back surface reading process, and a back surface printing condition setting process. The front surface printing process and the back surface printing process are performed in parallel.

### CROSS-REFERENCE TO RELATED APPLICATIONS

This application claims priority to Japanese Patent Application No. 2025-048099 filed on Mar. 24, 2025 entitled “Print Apparatus and Adjustment Method Therefor”, the content of which is incorporated herein by reference.

### BACKGROUND OF THE INVENTION

### Field of the Invention

The present invention relates to a double-sided printing apparatus that performs printing by ejecting ink from a nozzle, and an adjustment method therefor.

### Description of Related Art

There has been known an inkjet printing apparatus that performs printing by ejecting ink onto a base material (print paper or the like) by heat or pressure. The inkjet printing apparatus is provided with, for example, a plurality of inkjet heads extending in a direction orthogonal to a conveyance direction of a base material for each color of ink. Each inkjet head includes many nozzles for ejecting ink. By performing printing on the roll paper with the configuration as described above, high-speed printing in a one-pass method has been implemented. Thus, inkjet printing apparatuses have been widely employed, especially for on-demand printing.

When printing is performed by such an inkjet printing apparatus, various adjustments are performed so as to obtain good printing quality. Specifically, before printing for actually obtaining the target printed matter is performed, an adjustment process including calculation, settings, and the like of adjustment data (e.g., correction values) is performed, the calculation, the settings, and the like being corresponding to the results of printing an inspection chart and reading the printed image of the inspection chart by an image sensor, an colorimeter, and the like.

In general, in the inkjet printing apparatus, adjustments are required for a plurality of adjustment items. For example, in a certain inkjet printing apparatus, adjustments for four adjustment items (level-difference adjustment, shading adjustment, density adjustment, and defective nozzle compensation) are performed. The level-difference adjustment is intended to correct a deviation (level difference) between the inkjet heads caused by differences in type and thickness of a base material used and a difference in printing mode, and is an operation to adjust the ink ejection timing for each appropriate adjustment unit (e.g., inkjet head unit or nozzle unit). The shading adjustment is intended to reduce the variation in density between the inkjet heads. Specifically, the shading adjustment is an operation to measure a density of a portion corresponding to each nozzle by printing an inspection chart of a predetermined density and then optically reading the inspection chart, and correct the ink ejection amount for each nozzle in accordance with the difference between the density obtained by the measurement and the predetermined density so as to obtain the print result of the same density in all the nozzles, thereby reducing the density unevenness. The density adjustment is intended to adjust the maximum density and intermediate density of each ink color, such as cyan color (C color), magenta color (M color), yellow color (Y color), and black color (K color) and is an operation to adjust data of a gradation correction table for each ink color. The defective nozzle compensation is intended to make defects in the printed image less noticeable by causing nozzles adjacent to a defective nozzle (a nozzle in an ejection failure state) to eject a greater amount of ink than normal when there is the defective nozzle and is an operation to adjust an ejection amount of ink from the nozzles adjacent to the defective nozzle.

By the way, in a case in which the adjustments for the plurality of adjustment items as described above are performed in an inappropriate order, some adjustment items may not be adjusted properly (parameter values may not be set to appropriate values for some adjustment items). For example, in a case in which the shading adjustment is performed before performing the level-difference adjustment, the amount of ink ejected from each nozzle is adjusted in a state where the timing to eject ink from each nozzle has not been adjusted. This causes the density of the image obtained by the actual printing to differ from the desired density. Further, for example, in a case in which the density adjustment is performed before performing the shading adjustment, the density varies depending on the position of the inkjet head. From the above, at the time of performing the adjustment processes for the plurality of adjustment items, it is necessary to consider the order of adjustments for the plurality of adjustment items. However, performing adjustments for the plurality of adjustment items one item by one item while considering the adjustment order places an extremely heavy operational burden on an operator.

Japanese Laid-Open Patent Publication No. 2024-003941 discloses an invention for the inkjet printing apparatus capable of executing the batch adjustment process of performing adjustment processes for a plurality of adjustment items in a batch in accordance with one instruction by an operator. According to the invention, the adjustment processes for the plurality of adjustment items can be performed, by a simple operation, in a short time while reducing waste paper as compared to the related art.

In the commercial printing field, the double-sided printing apparatuses capable of printing on both a front surface and a back surface of the base material are widely used. Although the aforementioned adjustment process should be performed also in the double-sided printing apparatus, the technology disclosed in Japanese Laid-Open Patent Publication No. 2024-003941 targets the single-sided printing apparatus. According to the technology, the conveyance speed (a speed at which the base material is conveyed) is decreased and increased in a period during which printing is not performed. If such a technique is applied to the double-sided printing apparatus, for example, the conveyance speed is decreased and increased in a period during which printing on the front surface is not performed, which prevents printing on the back surface from being performed at the desired conveyance speed. As a result, adjustments are not performed appropriately. Alternatively, it is conceivable to execute the batch adjustment process for only the front surface and the batch adjustment process for only the back surface separately. However, ultimately, since the batch adjustment process is executed twice, the overall processing time is increased and waste paper is also increased.

### SUMMARY OF THE INVENTION

Therefore, an object of the present invention is to provide a double-sided printing apparatus capable of performing adjustment processes for a plurality of adjustment items related to printing in a short time as compared to the related art while reducing waste paper.

One aspect of the present invention is directed to a printing apparatus capable of printing on both a front surface of a base material having a long belt shape and a back surface of the base material, the printing apparatus including:
a conveyance mechanism configured to convey the base material in a predetermined conveyance direction;
a front surface print head configured to perform printing on the front surface of the base material by ejecting ink;
a front surface reader configured to read a printed image obtained by printing by the front surface print head;
a back surface print head configured to perform printing on the back surface of the base material by ejecting ink;
a back surface reader configured to read a printed image obtained by printing by the back surface print head; and
a controller configured to control operations of the conveyance mechanism, the front surface print head, the front surface reader, the back surface print head, and the back surface reader, wherein
a batch adjustment process of performing adjustment processes for a plurality of adjustment items related to printing based on one instruction from an outside is executable,
the batch adjustment process includes
a front surface printing process in which the front surface print head prints a front surface inspection chart corresponding to a processing-target adjustment item,
a front surface reading process in which the front surface reader reads a printed image of the front surface inspection chart,
a front surface printing condition setting process in which the controller sets a printing condition related to printing on the front surface of the base material based on front surface read data obtained by the front surface reading process,
a back surface printing process in which the back surface print head prints a back surface inspection chart corresponding to the processing-target adjustment item,
a back surface reading process in which the back surface reader reads a printed image of the back surface inspection chart, and
a back surface printing condition setting process in which the controller sets a printing condition related to printing on the back surface of the base material based on back surface read data obtained by the back surface reading process,
the front surface printing process and the back surface printing process are performed in parallel, and
regarding a preceding adjustment item and a subsequent adjustment item that are two adjustment items for which adjustment processes are performed consecutively in the batch adjustment process,
   the front surface printing process for the subsequent adjustment item begins in such a way that a distance from an end position of the front surface inspection chart corresponding to the preceding adjustment item to a start position of the front surface inspection chart corresponding to the subsequent adjustment item is equal to or larger than a sum of a distance the base material is conveyed during a period from an end time point of the front surface reading process for the preceding adjustment item to an end time point of the front surface printing condition setting process for the preceding adjustment item and a distance from the front surface print head to the front surface reader, and
   the back surface printing process for the subsequent adjustment item begins in such a way that a distance from an end position of the back surface inspection chart corresponding to the preceding adjustment item to a surface inspection chart start position of the back corresponding to the subsequent adjustment item is equal to or larger than a sum of a distance the base material is conveyed during a period from an end time point of the back surface reading process for the preceding adjustment item to an end time point of the back surface printing condition setting process for the preceding adjustment item and a distance from the back surface print head to the back surface reader.

According to such a configuration, the printing apparatus is configured to be able to execute a batch adjustment process of performing adjustment processes for a plurality of adjustment items related to printing in accordance with one instruction from an outside. Regarding the batch adjustment process, the front surface printing process in which the front surface print head prints the front surface inspection chart corresponding to the processing-target adjustment item and the back surface printing process in which the back surface print head prints the back surface inspection chart corresponding to the processing-target adjustment item are performed in parallel. Therefore, the back surface inspection chart can be printed in a region, regarding the conveyance direction of the base material, between a region where one front surface inspection chart is printed and a region where another front surface inspection chart is printed, and the front surface inspection chart can be printed in a region, regarding the conveyance direction of the base material, between a region where one back surface inspection chart is printed and a region where another back surface inspection chart is printed. Accordingly, regarding the adjustment processes for the plurality of adjustment items, the overall print length can be shortened compared to the related art and the blank portions on the base material can be reduced compared to the related art. From the above, regarding a printing apparatus capable of double-sided printing, it is possible to perform adjustment processes for the plurality of adjustment items related to printing in a short time as compared to the related art while reducing waste paper. Further, since waste paper can be reduced, it is possible to contribute to the achievement of the Sustainable Development Goals (SDGs).

Another aspect of the present invention is directed to an adjustment method for a printing apparatus capable of printing on both a front surface of a base material having a long belt shape and a back surface of the base material, the printing apparatus including
a conveyance mechanism configured to convey the base material in a predetermined conveyance direction;
a front surface print head configured to perform printing on the front surface of the base material by ejecting ink;
a front surface reader configured to read a printed image obtained by printing by the front surface print head;
a back surface print head configured to perform printing on the back surface of the base material by ejecting ink;
a back surface reader configured to read a printed image obtained by printing by the back surface print head; and
a controller configured to control operations of the conveyance mechanism, the front surface print head, the front surface reader, the back surface print head, and the back surface reader,
the adjustment method including:
issuing an instruction, by an operator, to the printing apparatus to execute a batch adjustment process of performing adjustment processes for a plurality of adjustment items related to printing; and
executing, by the printing apparatus, the batch adjustment process in accordance with the instruction, wherein
for each of the plurality of adjustment items, the batch adjustment process includes
an inspection chart printing process in which the front surface print head prints a front surface inspection chart corresponding to a processing-target adjustment item and the back surface print head prints a back surface inspection chart corresponding to the processing-target adjustment item, in parallel,
an inspection chart reading process in which the front surface reader reads a printed image of the front surface inspection chart to obtain front surface read data and the back surface reader reads a printed image of the back surface inspection chart to obtain back surface read data, in parallel, and
a printing condition setting process in which the controller sets a printing condition related to printing on the front surface of the base material based on the front surface read data and sets a printing condition related to printing on the back surface of the base material based on the back surface read data, and
regarding a preceding adjustment item and a subsequent adjustment item that are two adjustment items for which adjustment processes are performed consecutively in the batch adjustment process,
   printing the front surface inspection chart corresponding to the subsequent adjustment item in the inspection chart printing process for the subsequent adjustment item begins in such a way that a distance from an end position of the front surface inspection chart corresponding to the preceding adjustment item to a start position of the front surface inspection chart corresponding to the subsequent adjustment item is equal to or larger than a sum of a distance the base material is conveyed during a period from an end time point of reading the printed image of the front surface inspection chart in the inspection chart reading process for the preceding adjustment item to an end time point of setting the printing condition related to printing on the front surface of the base material in the printing condition setting process for the preceding adjustment item and a distance from the front surface print head to the front surface reader, and
   printing the back surface inspection chart corresponding to the subsequent adjustment item in the inspection chart printing process for the subsequent adjustment item begins in such a way that a distance from an end position of the back surface inspection chart corresponding to the preceding adjustment item to a start position of the back surface inspection chart corresponding to the subsequent adjustment item is equal to or larger than a sum of a distance the base material is conveyed during a period from an end time point of reading the printed image of the back surface inspection chart in the inspection chart reading process for the preceding adjustment item to an end time point of setting the printing condition related to printing on the back surface of the base material in the printing condition setting process for the preceding adjustment item and a distance from the back surface print head to the back surface reader.

These and other objects, modes, and features, advantageous effects of the present invention will become more apparent from the following detailed description of the present invention with reference to the accompanying drawings.

### BRIEF DESCRIPTION OF THE DRAWINGS

FIG. 1 is an overall configuration diagram of a printing system according to a first embodiment of the present invention;

FIG. 2 is a schematic diagram showing a configuration example of an inkjet printing apparatus in the first embodiment;

FIG. 3 is a plan view showing a configuration example of a print head in the first embodiment;

FIG. 4 is a block diagram showing a hardware configuration of a print controller in the first embodiment;

FIG. 5 is a flowchart for explaining the sequence of adjustment processes in the first embodiment;

FIG. 6 is a block diagram showing a schematic functional configuration of a control unit implemented by executing a print control program in the print controller in the first embodiment;

FIG. 7 is a diagram showing a first example of an adjustment item setting screen in the first embodiment;

FIG. 8 is a diagram showing a second example of the adjustment item setting screen in the first embodiment;

FIG. 9 is a flowchart showing a flow of a batch adjustment process in the first embodiment;

FIG. 10 is a for explaining print data corresponding to an overall chart in the first embodiment;

FIG. 11 is a diagram for explaining generation of adjustment process print data in the first embodiment;

FIG. 12 is a diagram for explaining print length of an inspection chart in the first embodiment;

FIG. 13 is a diagram for explaining that multiple processes are actually performed in parallel in the first embodiment;

FIG. 14 is a diagram schematically showing an example of transition of a state of the print paper over time in the first embodiment;

FIG. 15 is a diagram for explaining the number of sheets printed in a single printing process in the first embodiment;

FIG. 16 is a diagram for explaining start timing of the printing process for a subsequent adjustment item in the first embodiment;

FIG. 17 is a diagram for explaining that the number of sheets printed in a single printing process may be increased beyond a predetermined number in the first embodiment;

FIG. 18 is a diagram for explaining a case in which print length of the predefined inspection chart is longer than an inter-heads distance in the first embodiment;

FIG. 19 is a diagram for explaining effects obtained by the first embodiment;

FIG. 20 is a flowchart showing a flow of the batch adjustment process in a second embodiment of the present invention;

FIG. 21 is a diagram for explaining a first specific example in which a confirmation chart is a simpler chart compared to an adjustment chart in a third embodiment of the present invention;

FIG. 22 is a diagram for explaining a second specific example in which the confirmation chart is a simpler chart compared to the adjustment chart in the third embodiment;

FIG. 23 is a diagram showing a first example of the adjustment item setting screen in the third embodiment;

FIG. 24 is a diagram showing a second example of the adjustment item setting screen in the third embodiment;

FIG. 25 is a flowchart showing a flow of the batch adjustment process in the third embodiment;

FIG. 26 is a diagram schematically showing an example of a state of the print paper in a case in which readjustment is not performed in the third embodiment;

FIG. 27 is a diagram schematically showing an example of a state of the print paper in a case in which provisional adjustment process and confirmation process are re-performed for only the front surface in the third embodiment;

FIG. 28 is a diagram schematically showing an example of a state of the print paper in a case in which provisional adjustment process and confirmation process are re-performed for both the front surface and the back surface in the third embodiment;

FIG. 29 is a diagram for explaining inspection charts (the adjustment chart and the confirmation chart) in a modification of the third embodiment;

FIG. 30 is a flowchart showing a flow of the batch adjustment process in the modification; and

FIG. 31 is a diagram schematically showing an example of a state of the print paper in a case in which processes after confirmation printing process are re-performed for only the front surface in the modification.

### DETAILED DESCRIPTION OF PREFERRED EMBODIMENT

Embodiments of the present invention will be described below with reference to the accompanying drawings.

### 1. First Embodiment

### <1.1 Overall Configuration of Printing System>

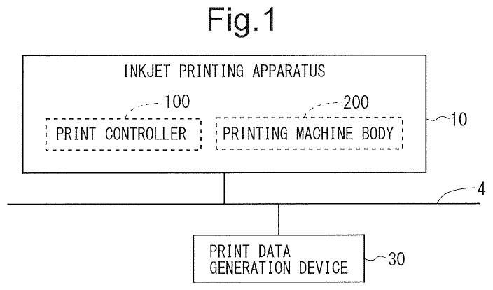

FIG. 1 is an overall configuration diagram of a printing system according to a first embodiment of the present invention. The printing system includes an inkjet printing apparatus 10 and a print data generation device 30. The inkjet printing apparatus 10 is a so-called double-sided printing apparatus capable of printing on both a front surface and a back surface of the print paper, which is a base material. The inkjet printing apparatus 10 and the print data generation device 30 are connected to each other through a local-area network (LAN) 4. The print data generation device 30 generates print data by performing a raster image processor (RIP) process or the like to submitted data such as a portable document format (PDF) file. The print data generated by the print data generation device 30 is transmitted to the inkjet printing apparatus 10 through the LAN 4. The inkjet printing apparatus 10 outputs a printed image to the print paper based on the print data transmitted from the print data generation device 30 without using a printing plate. The inkjet printing apparatus 10 includes a printing machine body 200, and a print controller 100 for controlling the operation of the printing machine body 200.

### <1.2 Configuration of Inkjet Printing Apparatus>

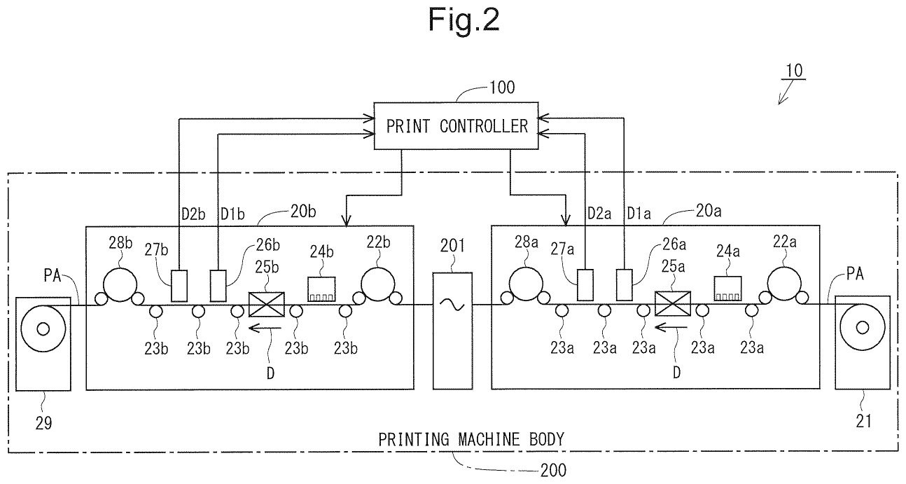

FIG. 2 is a schematic diagram showing a configuration example of the inkjet printing apparatus 10. As described above, the inkjet printing apparatus 10 includes the print controller 100 and the printing machine body 200. The printing machine body 200 includes a paper feeding unit 21 for supplying the print paper (e.g., a roll paper having a long belt shape) PA, a printing mechanism 20a for front surface printing, a reversing unit 201 that reverses the front surface of the print paper PA and the back surface thereof, a printing mechanism 20b for back surface printing, and a paper winding unit 29 for winding the print paper PA after printing. It should be noted that the present invention can also be applied to an inkjet printing apparatus having a configuration that enables printing on both the front surface and the back surface of the print paper PA without using the reversal unit 201.

The printing mechanism 20a for front surface printing includes a first drive roller 22a for conveying the print paper PA to the inside, a plurality of support rollers 23 for conveying the print paper PA inside the printing mechanism 20a, a front surface print head (inkjet head group) 24a for performing printing by ejecting ink onto the print paper PA, a front surface drying mechanism 25a for drying the print paper PA after printing, a front surface imaging device 26a for capturing the printed image (print paper PA after printing), a front surface colorimeter 27a for performing colorimetry of the printed image, and a second drive roller 28a for outputting the print paper PA from the inside of the printing mechanism 20a. Similarly, the printing mechanism 20b for back surface printing includes a first drive roller 22b, a plurality of support rollers 23b, a back surface print head 24b, a back surface drying mechanism 25b, a back surface imaging device 26b, a back surface colorimeter 27b, and a second drive roller 28b. As each of the front surface imaging device 26a and the back surface imaging device 26b, for example, a contact image sensor (CIS) using a complementary metal-oxide-semiconductor (CMOS) is employed. As each of the front surface colorimeter 27a and the back surface colorimeter 27b, for example, an in-line colorimeter is employed.

In the following, for convenience of explanation, the front surface imaging device 26a and the front surface colorimeter 27a are assumed to be located at the same position, and the front surface imaging device 26a and the front surface colorimeter 27a are collectively referred to as a “front surface reader”. Similarly, the back surface imaging device 26b and the back surface colorimeter 27b are assumed to be located at the same position, and the back surface imaging device 26b and the back surface colorimeter 27b are collectively referred to as a “back surface reader”. Further, in the following, when the front surface print head 24a and the back surface print head 24b are not distinguished, the print head is denoted by reference numeral 24.

The print controller 100 controls the operation of the printing machine body 200 having the configuration as above. When a printout instruction command is given to the print controller 100, the print controller 100 controls the operation of the printing machine body 200 so that the print paper PA is conveyed in a conveyance direction D from the paper feeding unit 21 to the paper winding unit 29. Then, printing onto the front surface of the print paper PA, drying the print paper PA, capturing the printed image on the front surface, and colorimetry of the printed image on the front surface are performed in the printing mechanism 20a for front surface printing, and printing onto the back surface of the print paper PA, drying the print paper PA, capturing the printed image on the back surface, and colorimetry of the printed image on the back surface are performed in the printing mechanism 20b for back surface printing. In the present embodiment, front surface imaging data D1a obtained by capturing the printed image by the front surface imaging device 26a, front surface colorimetric data D2a obtained by colorimetry of the printed image by the front surface colorimeter 27a, back surface imaging data D1b obtained by capturing the printed image by the back surface imaging device 26b, and back surface colorimetric data D2b obtained by colorimetry of the printed image by the back surface colorimeter 27b are transmitted to the print controller 100.

Although a single print controller 100 for both the printing mechanism 20a for front surface printing and the printing mechanism 20b for back surface printing is provided in the example shown in FIG. 2, the configuration may be such that a print controller for the printing mechanism 20a for front surface printing and a print controller for the printing mechanism 20b for back surface printing are provided, and these printing mechanism 20a and 20b control the operation of the printing machine body 200 in cooperation with each other.

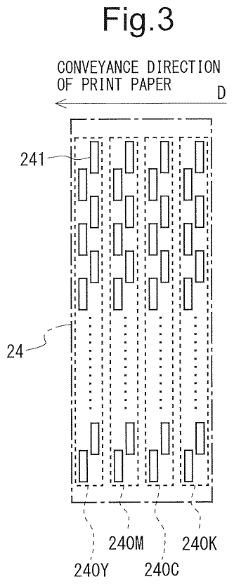

FIG. 3 is a plan view showing a configuration example of the print head 24. As shown in FIG. 3, the print head 24 includes inkjet head rows 240K, 240C, 240M, and 240Y of black color (K color), cyan color (C color), magenta color (M color), and yellow color (Y color) arranged in a row in the conveyance direction D of the print paper PA. Each inkjet head row is formed of a plurality of inkjet heads 241 arranged in a staggered manner. Each inkjet head 241 includes many nozzles that eject ink. Each nozzle of the inkjet head 241 included in the K-color inkjet head row 240K ejects the K-color ink, each nozzle of the inkjet head 241 included in the C-color inkjet head row 240C ejects the C-color ink, each nozzle of the inkjet head 241 included in the M-color inkjet head row 240M ejects the M-color ink, and each nozzle of the inkjet head 241 included in the Y-color inkjet head row 240Y ejects the Y-color ink.

### <1.3 Hardware Configuration of Print Controller>

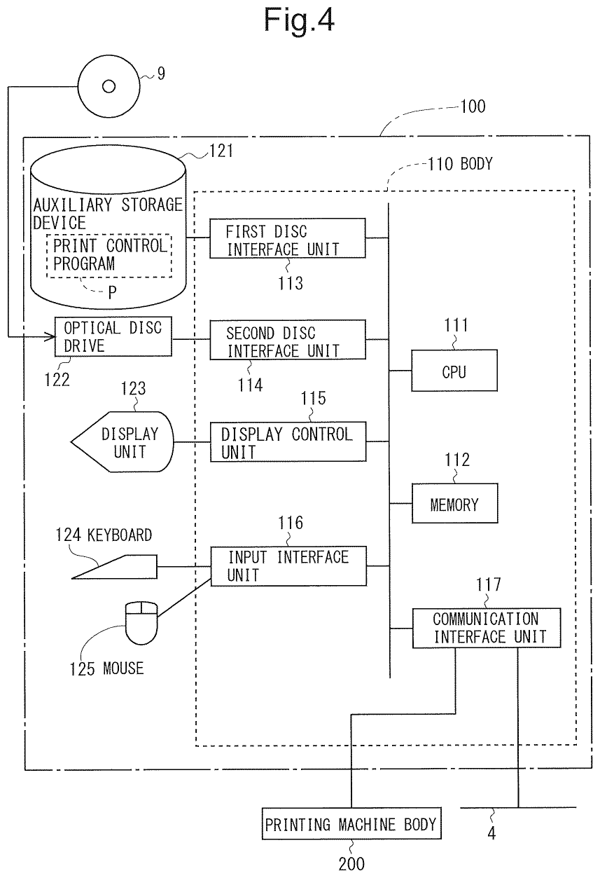

FIG. 4 is a block diagram showing a hardware configuration of the print controller 100. As shown in FIG. 4, the print controller 100 includes a body 110, an auxiliary storage device 121, an optical disc drive 122, a display unit 123, a keyboard 124, a mouse 125, and the like. The body 110 includes a central processing unit (CPU) 111, a memory 112, a first disc interface unit 113, a second disc interface unit 114, a display control unit 115, an input interface unit 116, and a communication interface unit 117. The CPU 111, the memory 112, the first disc interface unit 113, the second disc interface unit 114, the display control unit 115, the input interface unit 116, and the communication interface unit 117 are connected to each other via a system bus. The auxiliary storage device 121 is connected to the first disc interface unit 113. The optical disc drive 122 is connected to the second disc interface unit 114. The display unit (display device) 123 is connected to the display control unit 115. The keyboard 124 and the mouse 125 are connected to the input interface unit 116. The printing machine body 200 is connected to the communication interface unit 117 via a communication cable. The communication interface unit 117 is connected to the LAN 4. The auxiliary storage device 121 is a magnetic disk device or the like. The optical disc 9 as a computer-readable recording medium such as a compact disc read-only memory (CD-ROM) or a digital versatile disc read-only memory (DVD-ROM) is inserted into the optical disc drive 122. The display unit 123 is a liquid crystal display or the like. The display unit 123 is used to display information desired by an operator. The keyboard 124 and the mouse 125 are used by the operator to input instructions to the print controller 100.

The auxiliary storage device 121 stores a print control program (a program for controlling the execution of a printing process by the printing machine body 200) P. The CPU 111 reads the print control program P stored in the auxiliary storage device 121 into the memory 112 and executes the program to achieve various functions of the print controller 100. The memory 112 includes a random-access memory (RAM) and a read-only memory (ROM). The memory 112 functions as a work area for the CPU 111 to execute the print control program P stored in the auxiliary storage device 121. Note that the print control program P is provided by being stored into the computer-readable recording medium (non-transitory recording medium). That is, for example, the user purchases the optical disc 9 as the recording medium of the print control program P, inserts the optical disc 9 into the optical disc drive 122, reads the print control program P from the optical disc 9, and installs the print control program P in the auxiliary storage device 121.

### <1.4 Overview of Batch Adjustment Process>

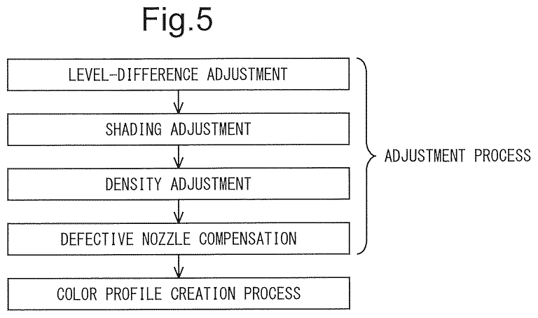

The inkjet printing apparatus 10 according to the present embodiment is provided with a function to execute a batch adjustment process of performing adjustment processes for a plurality of adjustment items in accordance with one operation of the operator. In other words, the inkjet printing apparatus 10 is configured to be able to execute the batch adjustment process of performing the adjustment processes for the plurality of adjustment items related to printing in accordance with one instruction from outside. In the batch adjustment process, an adjustment process for front surface printing (hereinafter referred to as a “front surface adjustment process”) and an adjustment process for back surface printing (hereinafter referred to as a “back surface adjustment process”) are performed in parallel. In the present embodiment, the level-difference adjustment, the shading adjustment, the density adjustment, and the defective nozzle compensation are performed in this order as the adjustment processes for the plurality of adjustment items by the batch adjustment process (cf. FIG. 5). Further, in the batch adjustment process, the color profile creation process is performed in addition to the adjustment processes for the plurality of adjustment items (cf. FIG. 5). Concerning the density adjustment, it has been common in the past to separately perform a process of adjusting the density of a so-called “solid” and a process of adjusting the density of halftones, but in the present embodiment, it is assumed that both are performed together in the batch adjustment process.

### <1.5 Configuration of Control Unit>

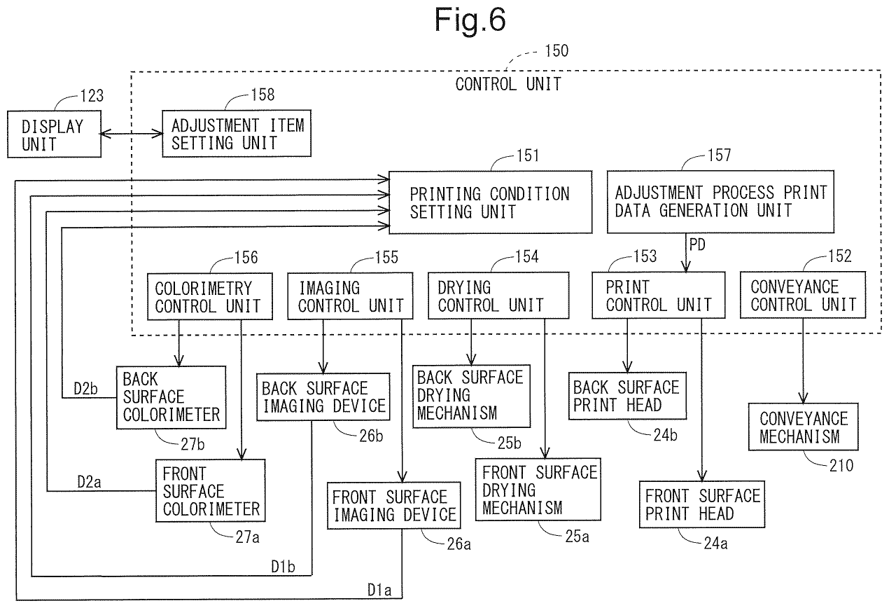

FIG. 6 is a block diagram showing a schematic functional configuration of the control unit 150 implemented by the print controller 100 executing the print control program P. The control unit 150 schematically includes a printing condition setting unit 151, a conveyance control unit 152, a print control unit 153, a drying control unit 154, an imaging control unit 155, a colorimetry control unit 156, an adjustment process print data generation unit 157, and an adjustment item setting unit 158.

The printing condition setting unit 151 sets printing conditions to be referred to by the control unit 150 during printing. In the present embodiment, in the batch adjustment process, for each adjustment item, the printing condition setting unit 151 sets the printing conditions for front surface printing based on the front surface imaging data D1a obtained by capturing the printed image by the front surface imaging device 26a or the front surface colorimetric data D2a obtained by colorimetry of the printed image by the front surface colorimeter 27a and sets the printing conditions for back surface printing based on the back surface imaging data D1b obtained by capturing the printed image by the back surface imaging device 26b or the back surface colorimetric data D2b obtained by colorimetry of the printed image by the back surface colorimeter 27b.

The conveyance control unit 152 controls the speed (conveyance speed) at which a conveyance mechanism 210 conveys the print paper PA. In the present embodiment, the conveyance mechanism 210 is implemented by the paper feeding unit 21, the first drive roller 22a and 22b, the plurality of support rollers 23a and 23b, the second drive roller 28a and 28b, and the paper winding unit 29 (cf. FIG. 2).

The print control unit 153 controls the ejection of ink from each of the nozzles included in the inkjet heads 241 constituting the print head 24 (the front surface print head 24a and the back surface print head 24b) in accordance with the set printing conditions. For example, the ink ejection timing and the ink ejection amount are controlled in accordance with the printing conditions. The drying control unit 154 controls a temperature (drying temperature) when each of the front surface drying mechanism 25a and the back surface drying mechanism 25b dries the print paper PA.

The imaging control unit 155 controls the timing to capture the printed image by each of the front surface imaging device 26a and the back surface imaging device 26b. The colorimetry control unit controls the timing to perform colorimetry of the printed image by each of the front surface colorimeter 27a and the back surface colorimeter 27b. The adjustment process print data generation unit 157 generates adjustment process print data PD, which is halftone dot data representing the inspection chart to be printed on the print paper PA during the batch adjustment process.

The adjustment item setting unit 158 displays, on the display unit 123, an adjustment item setting screen for externally setting whether to perform, for each of the plurality of adjustment items, each of the front surface adjustment process and the back surface adjustment process, and accepts settings from outside. Regarding this, two examples for the adjustment item setting screen are described below.

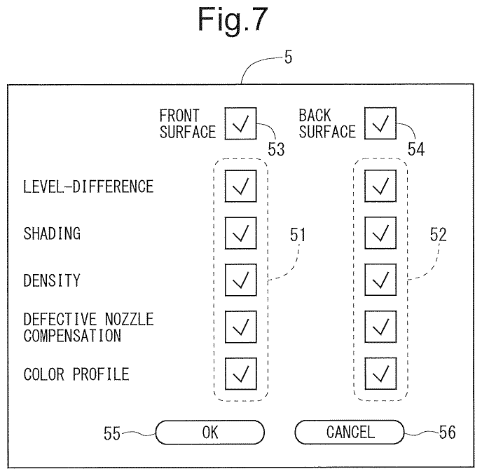

FIG. 7 is a diagram showing a first example of the adjustment item setting screen 5 in the present embodiment. The adjustment item setting screen 5 shown in FIG. 7 includes a first checkbox group 51 consisting of five checkboxes provided to correspond one-to-one to five items (four adjustment items and color profile creation), a second checkbox group 52 consisting of five checkboxes provided to correspond one-to-one to the above five items, a checkbox 53, a checkbox 54, an OK button 55, and a cancel button 56.

The first checkbox group 51 is used to set whether to perform the front surface adjustment process for each item. The second checkbox group 52 is used to set whether to perform the back surface adjustment process for each item. When checkbox 53 transitions from an unchecked state to a checked state, all checkboxes included in the first checkbox group 51 become checked state. When the checkbox 53 transitions from the checked state to the unchecked state, all checkboxes included in the first checkbox group 51 become unchecked state. When the checkbox 54 transitions from the unchecked state to the checked state, all checkboxes included in the second checkbox group 52 become checked state. When the checkbox 54 transitions from the checked state to the unchecked state, all checkboxes included in the second checkbox group 52 become unchecked state. When the OK button 55 is pressed, settings set using the adjustment item setting screen 5 are saved. When the cancel button 56 is pressed, settings set using the adjustment item setting screen 5 are discarded, and the previous settings are maintained.

FIG. 8 is a diagram showing a second example of the adjustment item setting screen 5 in the present embodiment. Except for the region where the OK button 55 and the cancel button 56 are located, the adjustment item setting screen 5 shown in FIG. 8 is divided into a first region 501 for settings related to the level-difference adjustment, the shading adjustment, the density adjustment, and the color profile creation, and a second region 502 for settings related to the defective nozzle compensation. The first checkbox group 51, the second checkbox group 52, the checkbox 53, and the checkbox 54 are included in the first region 501, and these are the same as those in the first example (cf. FIG. 7). A checkbox 57 for setting whether to perform the front surface adjustment process for the defective nozzle compensation and a checkbox 58 for setting whether to perform the back surface adjustment process for the defective nozzle compensation are included in the second region 502. Since the defective nozzle compensation may be performed less frequently than other adjustment items, the configuration shown in FIG. 8 may be adopted as the configuration of the adjustment item setting screen 5 for the convenience of the operator's operation.

### <1.6 Details of Batch Adjustment Process>

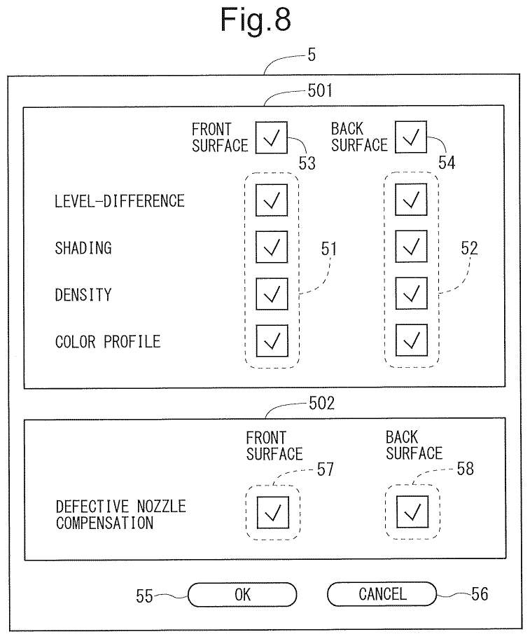

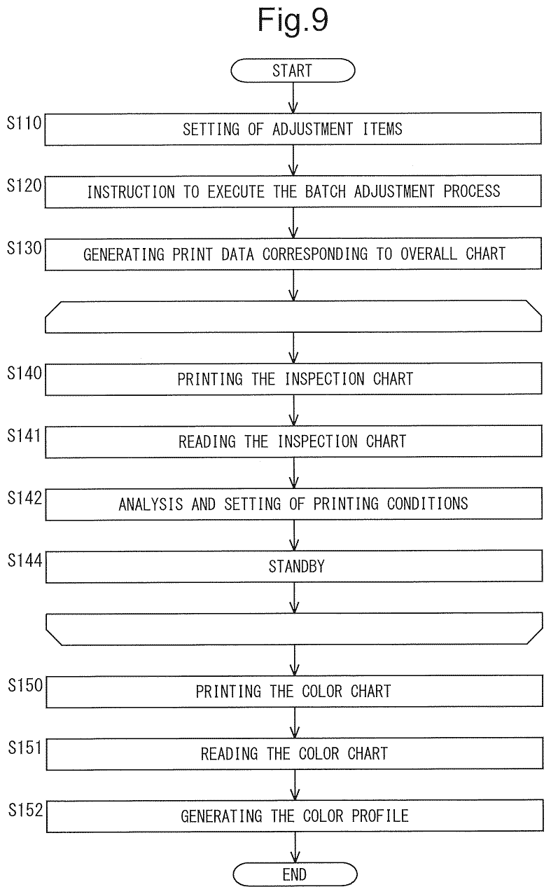

Next, the flow of the batch adjustment process (the adjustment method) will be described with reference to the flowchart shown in FIG. 9. First, the operator sets whether to perform each of the front surface adjustment process and the back surface adjustment process for each adjustment item, using the adjustment item setting screen 5 (step S110).

After the setting process using the adjustment item setting screen 5 is ended, the operator presses a batch adjustment start button for instructing the print controller 100 to execute the batch adjustment process (step S120). It should be noted that the batch adjustment start button is included in a predetermined operation screen displayed on the display unit 123 of the print controller 100.

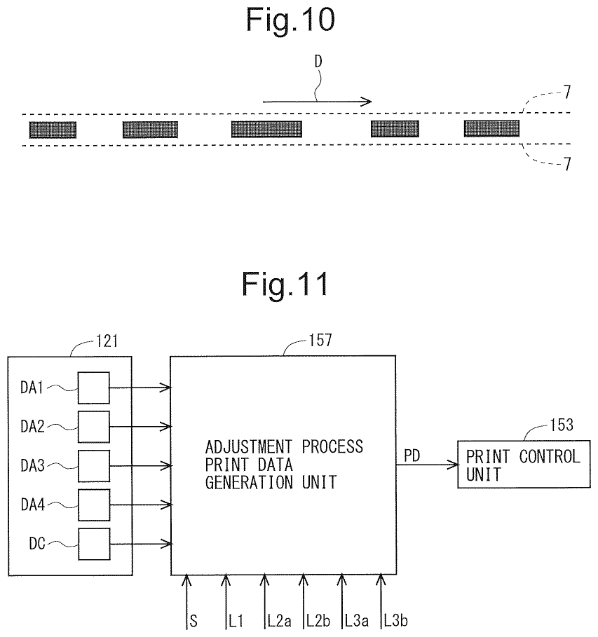

After the batch adjustment start button is pressed, a front surface print data corresponding to an overall chart to be printed on the front surface of the print paper PA by the batch adjustment process and a back surface print data corresponding to an overall chart to be printed on the back surface of the print paper PA by the batch adjustment process are generated as adjustment process print data PD (step S130). Specifically, the front surface print data is halftone dot data representing an image in which the inspection chart to be printed on the front surface of the print paper PA from a start time point of the batch adjustment process until an end time point thereof is disposed on the print paper PA along with the blank portions, the image being schematically shown in FIG. 10. The same applies to the back surface print data. It should be noted that the dotted line portions denoted by reference numeral 7 in FIG. 10 correspond to edge portions of the print paper PA. Regarding FIG. 10, the shaded portions represent the inspection charts printed continuously at one process. Each inspection chart includes a plurality of sheets. The reason why each inspection chart includes the plurality of sheets is because there are variations in the state of the printed image and adjustments can be performed more accurately to set printing conditions (update parameter values) based on an average value of values obtained by analyzing a plurality of sheets than to set printing conditions based on values obtained by analyzing one sheet. In the following, the inspection chart printed on the front surface of the print paper PA is referred to as a “front surface inspection chart” and the inspection chart printed on the back surface of the print paper PA is referred to as a “back surface inspection chart”.

Regarding generation of the adjustment process print data PD, the auxiliary storage device 121 (cf. FIG. 4) stores data for one sheet of the inspection chart corresponding to each adjustment item. That is, as shown in FIG. 11, the auxiliary storage device 121 stores data DA1 for one sheet of the inspection chart for the level-difference adjustment, data DA2 for one sheet of the inspection chart for the shading adjustment, data DA3 for one sheet of the inspection chart for the density adjustment, and data DA4 for one sheet of the inspection chart for the defective nozzle compensation, which are data for adjustment processes, in addition to data RC for color chart creation. Then, the adjustment process print data generation unit 157 generates the front surface print data and the back surface print data as the adjustment process print data PD using the data stored in the auxiliary storage device 121, based on the conveyance speed S, a distance from the front surface print head 24a to the back surface print head 24b (hereinafter, the distance is referred to as an “inter-heads distance”) L1, a distance L2a from the front surface print head 24a to the front surface reader, a distance L2b from the back surface print head 24b to the back surface reader, a product L3a of the number of sheets and a sheet length for the front surface inspection chart corresponding to each of the plurality of adjustment items, and a product L3b of the number of sheets and a sheet length for the back surface inspection chart corresponding to each of the plurality of adjustment items, such that inspection charts corresponding to the plurality of adjustment items are efficiently printed both on the front surface of the print paper PA and the back surface thereof.

After the adjustment process print data PD is generated, the processes of steps S140 to S144 described below are repeated the number of times equal to the number of adjustment items for which adjustment processes are performed.

In step S140, the inspection chart is printed. Specifically, a front surface printing process in which the front surface print head 24a prints the front surface inspection n chart corresponding to a processing-target adjustment item and a back surface printing process in which the back surface print head 24b prints the back surface inspection chart corresponding to the processing-target adjustment item are performed. It should be noted that the front surface printing process and the back surface printing process are collectively referred to as “printing process”.

By the way, if the front surface inspection chart and the back surface inspection chart are printed at the same position regarding the conveyance direction D of the print paper PA (in other words, if the back surface inspection chart is printed on the region where there is a show-through for the front surface inspection chart), adjustments for back surface printing are not performed appropriately. Therefore, in the back surface printing process, the back surface inspection chart is printed at the position where the front surface inspection chart is not printed, regarding the conveyance direction D of the print paper PA. In the step S130 described above, the adjustment process print data PD is generated such that the printing process as mentioned above is realized.

In step S141, the printed image of the inspection chart is read. Specifically, a front surface reading process in which the front surface imaging device 26a or the front surface colorimeter 27a reads the printed image of the front surface inspection chart and a back surface reading process in which the back surface imaging device 26b or the back surface colorimeter 27b reads the printed image of the back surface inspection chart are performed. It should be noted that the front surface reading process and the back surface reading process are collectively referred to as “reading process”.

In step S142, analysis of data obtained by the reading process and setting of printing conditions are performed. Specifically, a front surface printing condition setting process in which the printing condition setting unit 151 sets printing conditions related to printing on the front surface of the print paper PA based on front surface read data obtained by the front surface reading process and a back surface printing condition setting process in which the printing condition setting unit 151 sets printing conditions related to printing on the back surface of the print paper PA based on back surface read data obtained by the back surface reading process are performed. Regarding this, in the step S142, first, for each of the front surface and the back surface, adjustment data related to the adjustment for the processing-target adjustment item is obtained by analyzing the read data. Then, for each of the front surface and the back surface, parameter values for setting printing conditions are calculated based on the adjustment data, and the printing conditions are set (parameter values for the processing-target adjustment item are updated). More specifically, in the step S142, for example, ejection timing setting data is set in regard to the level-difference adjustment, shading correction data is set in regard to the shading adjustment, data setting of gradation correction table is performed in regard to the density adjustment, and a compensation coefficient for compensating for the amount of ink ejected from nozzles is set in regard to the defective nozzle compensation. It should be noted that the front surface printing condition setting process and the back surface printing condition setting process are collectively referred to as “printing condition setting process”.

After the printing condition setting process is ended, the front surface print head 24a is maintained in a standby state until the printable region (the region where the inspection chart should be printed) on the front surface of the print paper PA reaches the position of the front surface print head 24a, and the back surface print head 24b is maintained in a standby state until the printable region on the back surface of the print paper PA reaches the position of the back surface print head 24b (step S144).

When the processes of the steps S140 to S144 are ended for all of the plurality of adjustment items subject to the adjustment processes, the color chart is printed by each of the front surface print head 24a and the back surface print head 24b (step S150). Next, colorimetry of the printed image of the color chart is performed by each of the front surface colorimeter 27a and the back surface colorimeter 27b (step S151). Finally, the color profile for front surface printing is generated based on the front surface colorimetric data D2a obtained by the process of the step S151 and the color profile for back surface printing is generated based on the back surface colorimetric data D2b obtained by the process of the step S151 (step S152). Thus, the batch adjustment process ends. Examples of the color profile include an ICC profile. The ICC profile is a file of a format defined by the International Color Consortium for color space conversion and is a file that defines the characteristics of a color space of a device. By converting color data using the ICC profile, it is possible to reproduce a color as faithfully as possible between different devices.

It should be noted that issuing an instruction to the printing apparatus to execute a batch adjustment process is realized by the step S120, executing the batch adjustment process is realized by the steps S140 to S144, the inspection chart printing process is realized by the process of the step S140, and the inspection chart reading process is realized by the process of the step S141.

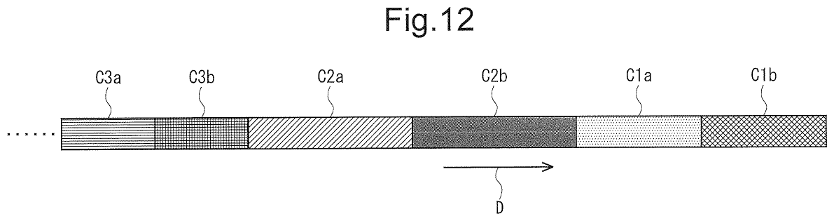

In the above-described manner, the adjustment processes for the plurality of adjustment items are performed. Regarding this, the print length of the inspection chart may be the same for all of the adjustment items, and the print length of the inspection chart may differ for each adjustment item, for example, as shown in FIG. 12. Regarding FIG. 12, the back surface inspection chart for the first adjustment item is denoted by reference sign C1b, the front surface inspection chart for the first adjustment item is denoted by reference sign C1a, the back surface inspection chart for the second adjustment item is denoted by reference sign C2b, the front surface inspection chart for the second adjustment item is denoted by reference sign C2a, the back surface inspection chart for the third adjustment item is denoted by reference sign C3b, and the front surface inspection chart for the third adjustment item is denoted by reference sign C3a.

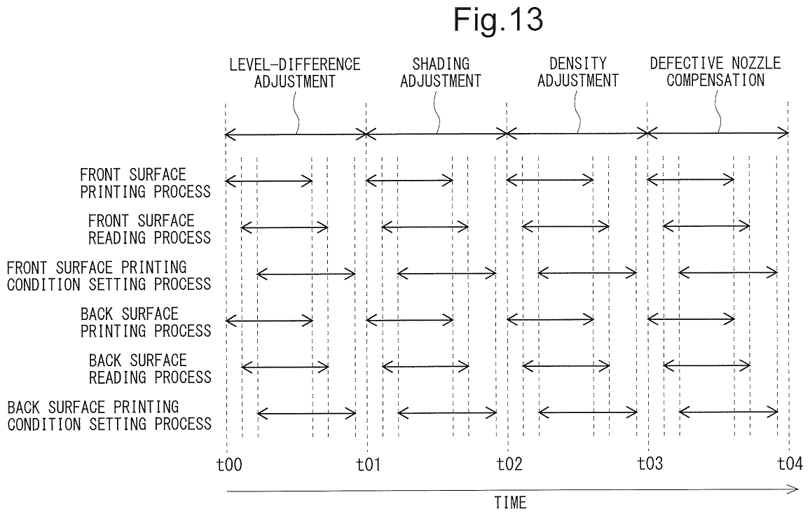

By the way, although the printing process, the reading process, and the printing condition setting process are performed sequentially one by one in the above explanation, in practice, these processes are performed in parallel for each adjustment item as shown in FIG. 13. For example, when focusing on the level-difference adjustment, first, the front surface printing process and the back surface printing process are started, next, the front surface reading process and the back surface reading process are started, and thereafter, the front surface printing condition setting process and the back surface printing condition setting process are started. After the front surface printing process, the back surface printing process, the front surface reading process, the back surface reading process, the front surface printing condition setting process, and the back surface printing condition setting process are performed in parallel for some time, the front surface printing process and the back surface printing process are ended. Next, the front surface reading process and the back surface reading process are ended, and thereafter, the front surface printing condition setting process and the back surface printing condition setting process are ended. The same applies to the adjustment items other than the level-difference adjustment. While the printing condition setting process includes a process of analyzing the read data and a process of updating the parameter values, since the process of updating the parameter values is performed in an extremely short time, the process of analyzing the read data is performed for most of a period during which the printing condition setting process is performed.

### <1.7 Details of Printing Process>

As described above, in the present embodiment, in the back surface printing process, the back surface inspection chart is printed at the position where the front surface inspection chart is not printed, regarding the conveyance direction D of the print paper PA. More specifically, the back surface inspection chart (excluding a back surface inspection chart that is first printed on the back surface of the print paper PA) is printed in a region, regarding the conveyance direction D of the print paper PA, between a region where the front surface inspection chart is printed and a region where the front surface inspection chart is next printed. How such printing process is performed will be explained below in detail. In the following, when focusing on two adjustment items for which the adjustment processes are performed consecutively in the batch adjustment process, an adjustment item for which the adjustment process is performed in first is referred to as a “preceding adjustment item”, and an adjustment item for which the adjustment process is subsequently performed is referred to as a “subsequent adjustment item”. For example, when focusing on the shading adjustment and the density adjustment (cf. FIG. 5), the shading adjustment is the preceding adjustment item and the density adjustment is the subsequent adjustment item.

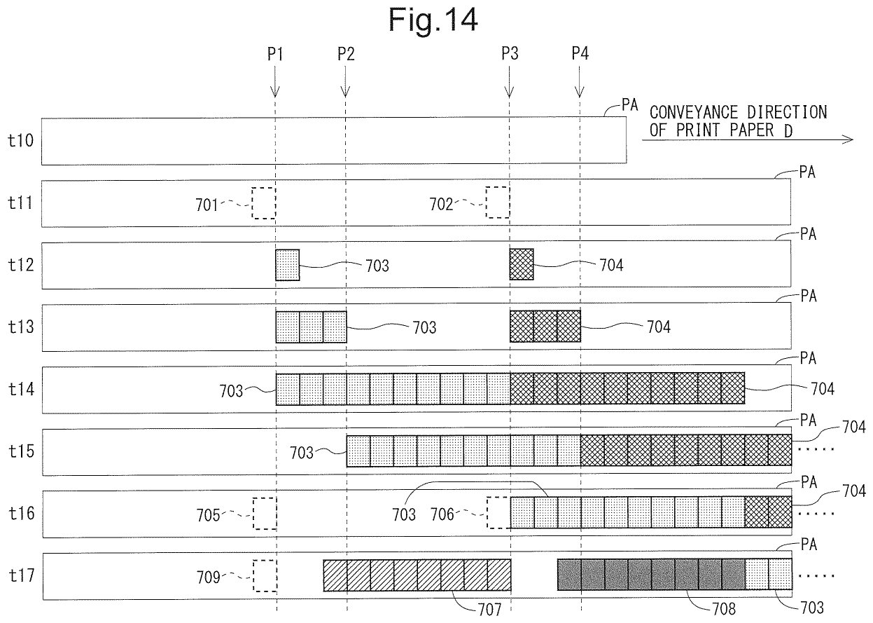

FIG. 14 is a diagram schematically showing an example of transition of a state of the print paper PA over time. In FIG. 14, an arrow denoted by reference sign P1 indicates the position of the front surface print head 24a, an arrow denoted by reference sign P2 indicates the position of the front surface reader, an arrow denoted by reference sign P3 indicates the position of the back surface print head 24b, and an arrow denoted by reference sign P4 indicates the position of the back surface reader. The back surface print head 24b is positioned downstream of the front surface print head 24a in the conveyance direction D of the print paper PA. It should be noted that, in FIG. 14, for convenience of explanation, the sizes of the front surface print head 24a, the front surface reader, the back surface print head 24b, and the back surface reader are ignored. Further, the reversing unit 201 is provided at a position between a position indicated by the arrow denoted by reference sign P2 and a position indicated by the arrow denoted by reference sign P3, and the reversing unit 201 reverses the front surface of the print paper PA and the back surface thereof.

Time t10 is a time immediately after the execution of the batch adjustment process begins. At the time t10, the conveyance speed of the print paper PA is increasing. Time t11 is a time at which printing of the inspection chart for the level-difference adjustment begins. The dotted line portion denoted by reference numeral 701 is a region where a first sheet of the front surface inspection chart for the level-difference adjustment should be printed and the dotted line portion denoted by reference numeral 702 is a region where a first sheet of the back surface inspection chart for the level-difference adjustment should be printed. Thus, in the present embodiment, the front surface printing process and the back surface printing process begin at same timing. However, the present invention is not limited thereto. As long as the front surface printing process and the back surface printing process are performed in parallel for at least some period, the front surface printing process and the back surface printing process do not necessarily need to begin at same timing. It should be noted that the conveyance speed has already reached a constant speed suitable for printing at the time t11. Then, after the time t11, until colorimetry of the printed image of the color chart is ended (that is, until the process of the step S151 in FIG. 9 is ended), the conveyance speed is maintained at the constant speed.

Time t12 is a time at which printing of the first sheet of the front surface inspection chart 703 for the level-difference adjustment and the first sheet of the back surface inspection chart 704 for the level-difference adjustment is ended. Time t13 is a time at which printing of the third sheet of the front surface inspection chart 703 for the level-difference adjustment and the third sheet of the back surface inspection chart 704 for the level-difference adjustment is ended. At the time t13, the start position of the front surface inspection chart 703 for the level-difference adjustment reaches the position of the front surface reader and the start position of the back surface inspection chart 704 for the level-difference adjustment reaches the position of the back surface reader. Accordingly, at the time t13, the front surface reading process and the back surface reading process are started.

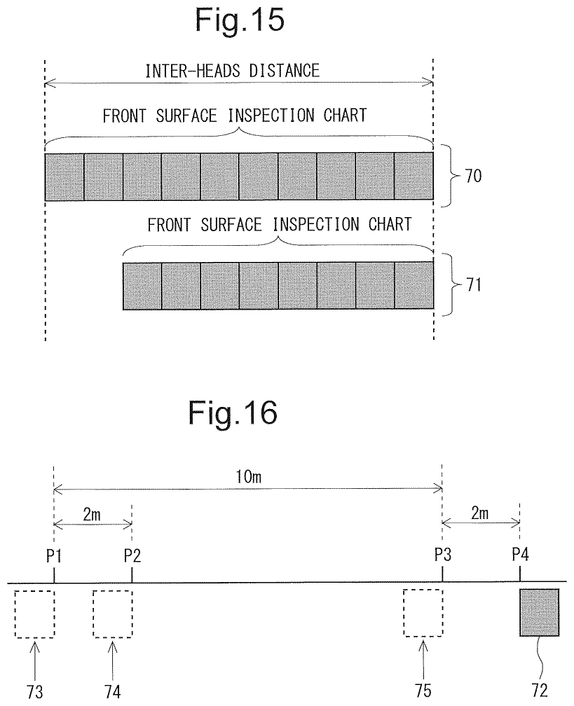

By the way, the back surface inspection chart 704 can be printed by the back surface print head 24b until the start position of the front surface inspection chart 703 for the level-difference adjustment reaches the position of the back surface print head 24b. When the start position of the front surface inspection chart 703 for the level-difference adjustment reaches the position of the back surface print head 24b, the print length of the front surface inspection chart 703 is equal to the inter-heads distance. Since the front surface printing process and the back surface printing process begin at same timing, when the start position of the front surface inspection chart 703 for the level-difference adjustment reaches the position of the back surface print head 24b, the print length of the back surface inspection chart 704 for the level-difference adjustment is also equal to the inter-heads distance. From the above, it can be understood that the maximum print length of the inspection chart printed continuously at one process in each of the front surface printing process and the back surface printing process is equal to the inter-heads distance. Thus, in the present embodiment, each of the print length of the front surface inspection chart printed continuously at one process in the front surface printing process and the print length of the back surface inspection chart printed continuously at one process in the back surface printing process is equal to or less than the inter-heads distance. Accordingly, the number of sheets printed by one front surface printing process is determined such that the print length of the front surface inspection chart printed by the front surface printing process becomes equal to the inter-heads distance as shown in the portion denoted by reference numeral 70 in FIG. 15 or the print length of the front surface inspection chart printed by the front surface printing process becomes less than the inter-heads distance as shown in the portion denoted by reference numeral 71 in FIG. 15. The same applies to the number of sheets printed by one back surface printing process.

Even in a case in which the print length of the inspection chart printed by one printing process is less than the inter-heads distance, for example, when a distance from the end position of the back surface inspection chart corresponding to the preceding adjustment item to the start position of the back surface inspection chart corresponding to the subsequent adjustment item is less than the inter-heads distance, the front surface inspection chart and the back surface inspection chart can be printed at the same position regarding the conveyance direction D of the print paper PA. Therefore, the back surface printing process for the subsequent adjustment item begins in such a way that the distance from the end position of the back surface inspection chart corresponding to the preceding adjustment item to the start position of the back surface inspection chart corresponding to the subsequent adjustment item is equal to or larger than the inter-heads distance. Similarly, the front surface printing process for the subsequent adjustment item begins in such a way that the distance from the end position of the front surface inspection chart corresponding to the preceding adjustment item to the start position of the front surface inspection chart corresponding to the subsequent adjustment item is equal to or larger than the inter-heads distance.

Regarding FIG. 14, time t14 is a time at which printing of the last sheet of the front surface inspection chart 703 for the level-difference adjustment and the last sheet of the back surface inspection chart 704 for the level-difference adjustment is ended. In this example, both the print length of the front surface inspection chart 703 for the level-difference adjustment and the print length of the back surface inspection chart 704 for the level-difference adjustment are equal to the inter-heads distance. Time t15 is a time at which reading of the last sheet of the front surface inspection chart 703 for the level-difference adjustment and the last sheet of the back surface inspection chart 704 for the level-difference adjustment is ended.

Time t16 is a time at which printing of the inspection chart for the shading adjustment begins. The dotted line portion denoted by reference numeral 705 is a region where a first sheet of the front surface inspection chart for the shading adjustment should be printed and the dotted line portion denoted by reference numeral 706 is a region where a first sheet of the back surface inspection chart for the shading adjustment should be printed. The first sheet of the back surface inspection chart for the shading adjustment is printed immediately following the last sheet of the front surface inspection chart 703 for the level-difference adjustment. That is, in this example, the back surface printing process for the subsequent adjustment item begins in such a way that the start position of the back surface inspection chart corresponding to the subsequent adjustment item is a position immediately following the end position of the front surface inspection chart corresponding to the preceding adjustment item.

By the way, the printing condition setting process (the front surface printing condition setting process and the back surface printing condition setting process) for the level-difference adjustment must be ended before printing of the inspection chart for the shading adjustment begins. That is, the printing condition setting process for the preceding adjustment item must be ended before the printing process for the subsequent adjustment item begins. It is necessary to determine start timing of the printing process for the subsequent adjustment item in consideration of the above. This will be explained in detail with reference to FIG. 16. Here, for the sake of convenience, this explanation assumes that the inter-heads distance is ten meters, each of the distance from the front surface print head 24a to the front surface reader and the distance from the back surface print head 24b to the back surface reader is two meters, and the conveyance speed is one meter per second. Further, this explanation assumes that the sheet denoted by reference numeral 72 is the last sheet of the back surface inspection chart corresponding to the preceding adjustment item. Under the above assumption, if the period from the end time point of the back surface reading process (the end time point of reading the last sheet of the back surface inspection chart) for the preceding adjustment item to the end time point of the back surface printing condition setting process for the preceding adjustment item is eight seconds, then the sheet portion that is positioned in a portion indicated by the arrow denoted by reference numeral 74 at the end time point of the back surface reading process reaches the position indicated by the arrow denoted by reference numeral 75 after eight seconds. In this example, if the distance from the end position of the back surface inspection chart corresponding to the preceding adjustment item to the start position of the back surface inspection chart corresponding to the subsequent adjustment item is equal to or larger than a sum of a distance (eight meters) the print paper PA is conveyed during a period (eight seconds) from the end time point of the back surface reading process to the end time point of the back surface printing condition setting process and a distance (two meters) from the back surface print head 24b to the back surface reader, then the back surface printing condition setting process for the preceding adjustment item is ended by the time point at which the back surface printing process for the subsequent adjustment item begins. Further, if the period from the end time point of the back surface reading process for the preceding adjustment item to the end time point of the back surface printing condition setting process for the preceding adjustment item is ten seconds, then the sheet portion that is positioned in a portion indicated by the arrow denoted by reference numeral 73 at the end time point of the back surface reading process reaches the position indicated by the arrow denoted by reference numeral 75 after ten seconds. In this example, if the distance from the end position of the back surface inspection chart corresponding to the preceding adjustment item to the start position of the back surface inspection chart corresponding to the subsequent adjustment item is equal to or larger than a sum of a distance (ten meters) the print paper PA is conveyed during a period (ten seconds) from the end time point of the back surface reading process to the end time point of the back surface printing condition setting process and a distance (two meters) from the back surface print head 24b to the back surface reader, then the back surface printing condition setting process for the preceding adjustment item is ended by the time point at which the back surface printing process for the subsequent adjustment item begins.

From the above, in the present embodiment, the back surface printing process for the subsequent adjustment item begins in such a way that a distance from the end position of the back surface inspection chart corresponding to the preceding adjustment item to the start position of the back surface inspection chart corresponding to the subsequent adjustment item is equal to or larger than a sum of a distance the print paper PA is conveyed during a period from the end time point of the back surface reading process for the preceding adjustment item to the end time point of the back surface printing condition setting process for the preceding adjustment item and a distance from the back surface print head 24b to the back surface reader. Similarly, the front surface printing process for the subsequent adjustment item begins in such a way that a distance from the end position of the front surface inspection chart corresponding to the preceding adjustment item to the start position of the front surface inspection chart corresponding to the subsequent adjustment item is equal to or larger than a sum of a distance the print paper PA is conveyed during a period from the end time point of the front surface reading process for the preceding adjustment item to the end time point of the front surface printing condition setting process for the preceding adjustment item and a distance from the front surface print head 24a to the front surface reader.

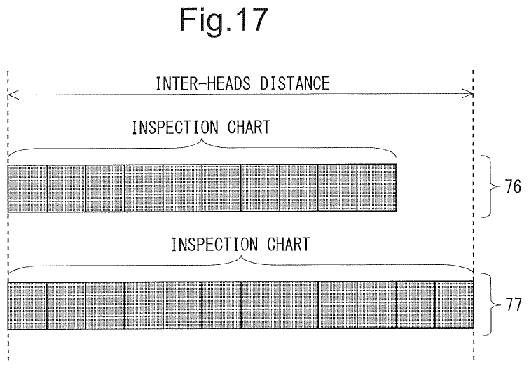

Time t17 is a time at which the start position of the front surface inspection chart 707 for the shading adjustment reaches the position of the back surface print head 24b. It should be noted that the back surface inspection chart for the shading adjustment is denoted by reference numeral 708, and the dotted line portion denoted by reference numeral 709 is a region where a first sheet of the back surface inspection chart for the density adjustment should be printed. In this example, the print length of the inspection chart for the shading adjustment is less than the inter-heads distance. In a case in which the print length of the predefined inspection chart is thus shorter than the inter-heads distance, the number of sheets of the inspection chart printed by one printing process may be increased, provided that the print length of the inspection chart printed by the one printing process is equal to or less than the inter-heads distance. For example, in a case in which the predefined inspection chart is a chart shown in a portion denoted by reference numeral 76 in FIG. 17, the inspection chart printed in practice may be a chart shown in a portion denoted by reference numeral 77 in FIG. 17. Thus, since the amount of data used for adjustments increases, the accuracy of the adjustments improves.

The front surface printing process and the back surface printing process are similarly performed after time t17. In this manner, regarding all combinations of the two adjustment items based on the plurality of adjustment items (in the example shown in FIG. 5, regarding “the level-difference adjustment and the shading adjustment”, “the shading adjustment and the density adjustment”, and “the density adjustment and the defective nozzle compensation”), the front surface printing process and the back surface printing process are performed in such a way that the front surface inspection chart corresponding to the preceding adjustment item is printed on a region, on the front surface, between the end position of the back inspection chart corresponding to the preceding adjustment item and the start position of the back surface inspection chart corresponding to the subsequent adjustment item, and the back surface inspection chart corresponding to the subsequent adjustment item is printed on a region, on the back surface, between the end position of the front surface inspection chart corresponding to the preceding adjustment item and the start position of the front surface inspection chart corresponding to the subsequent adjustment item. That is, the back surface inspection chart and the front surface inspection chart are alternately printed regarding the conveyance direction D of the print paper PA.

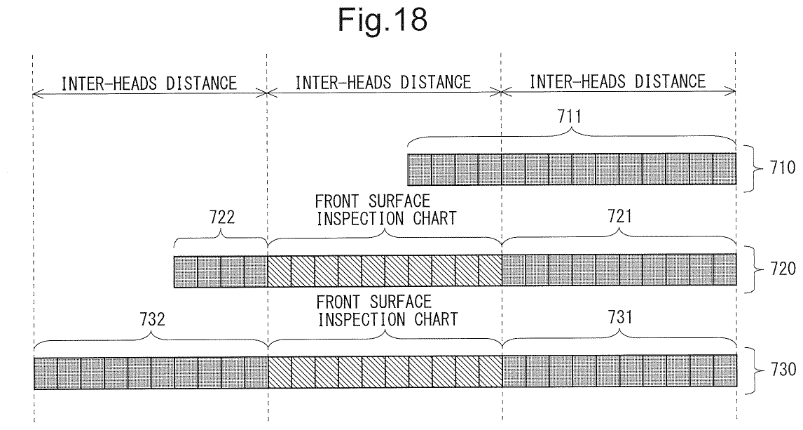

Although the print length of the predefined inspection chart is equal to or less than the inter-heads distance in the example shown in FIG. 14, there is a case in which the print length of the predefined inspection chart is longer than the inter-heads distance. For example, as shown in a portion denoted by reference numeral 710 in FIG. 18, there is a case in which the print length of the predefined back surface inspection chart 711 is longer than the inter-heads distance. In the present embodiment, in such a case, for example, as shown in a portion denoted by reference numeral 720 in FIG. 18, the predefined back surface inspection chart 711 is divided into a part 721 that is printed in first and a part 722 that is subsequently printed. The front surface inspection chart is printed in a region, regarding the conveyance direction D of the print paper PA, between the part 721 that is printed in first and the part 722 that is subsequently printed. It should be noted that, as shown in a portion denoted by reference numeral 730 in FIG. 18, not only the print length of the part 731 that is printed in first but also the print length of the part 732 that is subsequently printed may be equal to the inter-heads distance. As above, in the present embodiment, when a product of the number of sheets and a sheet length for the back surface inspection chart corresponding to the processing-target adjustment item is longer than the inter-heads distance, the back surface printing process is performed in a plurality of times such that the print length of the back surface inspection chart printed continuously at one process in the back surface printing process is equal to or less than the inter-heads distance. The same applies to the front surface printing process.

### <1.8 Effects>

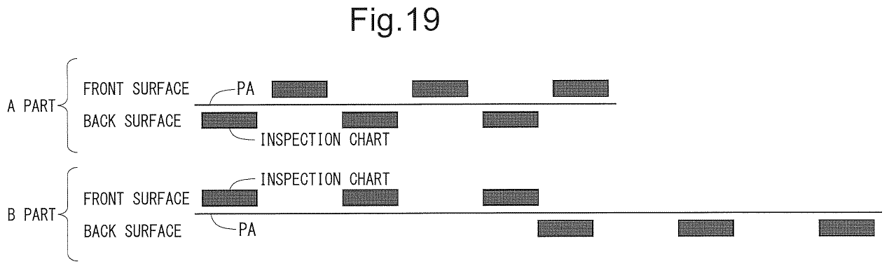

According to the present embodiment, the inkjet printing apparatus 10 is configured to be able to execute the batch adjustment process of performing adjustment processes for the plurality of adjustment items related to printing in accordance with one instruction by the operator. Regarding the batch adjustment process, the front surface printing process in which the front surface print head 24a prints the front surface inspection chart corresponding to the processing-target adjustment item and the back surface printing process in which the back surface print head 24b prints the back surface inspection chart corresponding to the processing-target adjustment item are performed in parallel. Therefore, the inspection chart can be printed on the print paper PA such that a state of the print paper PA after the batch adjustment process is a state as schematically shown in the A part of FIG. 19. That is, the back surface inspection chart can be printed in a region, regarding the conveyance direction D of the print paper PA, between a region where one front surface inspection chart is printed and a region where another front surface inspection chart is printed, and the front surface inspection chart can be printed in a region, regarding the conveyance direction D of the print paper PA, between a region where one back surface inspection chart is printed and a region where another back surface inspection chart is printed. In contrast, according to the related art in which the batch adjustment process for only the front surface is executed after executing the batch adjustment process for only the back surface, even if the first front surface inspection chart can be printed immediately following the end position of the last back surface inspection chart, a state of the print paper PA after the adjustment processes is a state as schematically shown in the B part of FIG. 19. It can be grasped from FIG. 19 that, according to the present embodiment, the overall print length can be shortened compared to the related art and the blank portions on the print paper PA are reduced compared to the related art. Thus, according to the present embodiment, regarding the inkjet printing apparatus 10 capable of double-sided printing, it is possible to perform adjustment processes for the plurality of adjustment items related to printing in a short time as compared to the related art while reducing waste paper. Further, since waste paper can be reduced, it is possible to contribute to the achievement of the Sustainable Development Goals (SDGs).

### 2. Second Embodiment

### <2.1 Outline and Configuration>

In the above-described first embodiment, after receiving an instruction to execute the batch adjustment process, first, print data (the front surface print data and the back surface print data) corresponding to the overall chart to be printed by the batch adjustment process is generated, and thereafter, the printing process is performed based on the print data. In contrast, in the present embodiment, print data corresponding to the overall chart is not generated, and for each adjustment item, print data corresponding to the inspection chart is generated immediately before the inspection chart is printed. In other words, print data for printing the inspection chart corresponding to the subsequent adjustment item is generated after setting of the printing conditions (updating parameter values) for the preceding adjustment item is performed.

The overall configuration of the printing system (cf. FIG. 1), the configuration of the inkjet printing apparatus 10 (cf. FIG. 2), the configuration of the print head 24 (cf. FIG. 3), the hardware configuration of the print controller 100 (cf. FIG. 4), and the schematic functional configuration of the control unit 150 (cf. FIG. 6) are the same as in the above-described first embodiment.

### <2.2 Batch Adjustment Process>

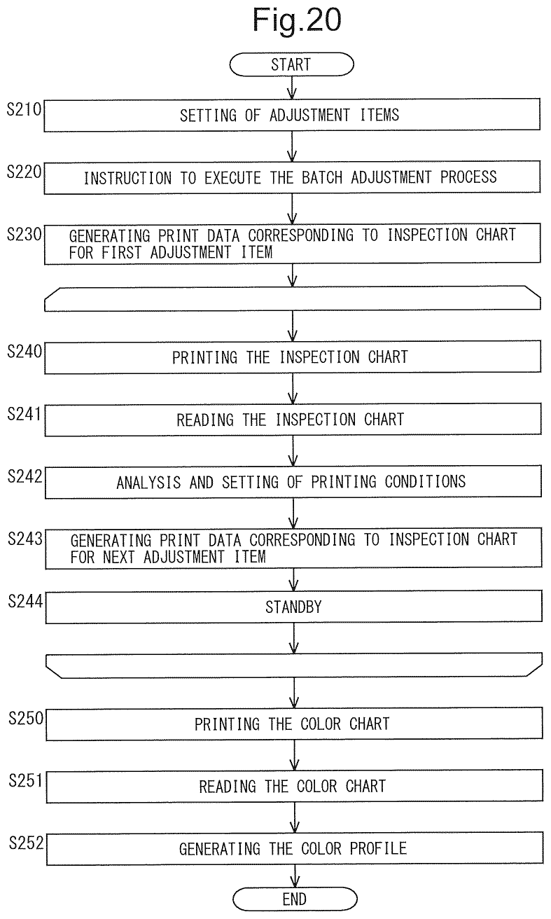

FIG. 20 is a flowchart for explaining a flow of the batch adjustment process (that is, a flowchart for explaining adjustment method) in the present embodiment. Steps S210 to S220 are the same as the steps S110 to S120 in FIG. 9. In step S230, the front surface print data corresponding to the front surface inspection chart for the first adjustment item (in the example shown in FIG. 5, the level-difference adjustment) and the back surface print data corresponding to the back surface inspection chart for the first adjustment item are generated as the adjustment process print data PD. Regarding this, as described above, the auxiliary storage device 121 stores data for one sheet of the inspection chart corresponding to each adjustment item. Then, the adjustment process print data generation unit 157 generates the front surface print data and the back surface print data as the adjustment process print data PD using the data stored in the auxiliary storage device 121, based on the conveyance speed S, the inter-heads distance L1, a distance L2a from the front surface print head 24a to the front surface reader, a distance L2b from the back surface print head 24b to the back surface reader, a product L3a of the number of sheets and a sheet length for the front surface inspection chart corresponding to the first adjustment item, and a product L3b of the number of sheets and a sheet length for the back surface inspection chart corresponding to the first adjustment item, such that the front surface inspection chart and the back surface inspection chart are not printed at the same position regarding the conveyance direction D of the print paper PA (cf. FIG. 6 and FIG. 11).

Steps S240 to S242 are the same as the steps S140 to S142 in FIG. 9. In step S243, similarly to the step S230, the front surface print data corresponding to the front surface inspection chart for next adjustment item and the back surface print data corresponding to the back surface inspection chart for the next adjustment item are generated as the adjustment process print data PD. Steps S244 to S252 are the same as the steps S144 to S152 in FIG. 9.

### <2.3 Effects>

According to the present embodiment, as in the above-described first embodiment, regarding the inkjet printing apparatus 10 capable of double-sided printing, it is possible to perform adjustment processes for the plurality of adjustment items related to printing in a short time as compared to the related art while reducing waste paper. In addition, since print data (adjustment process print data PD) for printing the inspection chart corresponding to subsequent adjustment item is generated after setting of the printing conditions (updating the parameter values) for the preceding adjustment item is performed, the blank portions on the print paper PA are reduced compared to the above-described first embodiment in which the print data corresponding to the overall chart is generated in advance. Accordingly, waste paper is reduced more effectively.

### 3. Third Embodiment

### <3.1 Outline and Configuration>

According to the invention disclosed in Japanese Laid-Open Patent Publication No. 2024-003941, in a case in which adjustments for the preceding adjustment item have not been appropriately performed for some reasons (specifically, in a case in which parameter values have not been set to adjustments for the subsequent appropriate values), adjustment item cannot be performed appropriately. In such a case, the user will recognize that adjustments have not been appropriately performed, by the printed image obtained by printing performed after the batch adjustment process. Then, for example, in a case in which the adjustment for the first adjustment item has not been appropriately performed, adjustments should be performed for all adjustment items. Thus, turn back of the processes when adjustments have not been appropriately performed is significant, and a large amount of waste paper may occur.

Therefore, in the present embodiment, the adjustment processes include a process for confirming whether the adjustment is appropriately performed for each adjustment item. That is, the adjustment process for each adjustment item includes a provisional adjustment process in which printing an adjustment chart (hereinafter referred to as “adjustment printing”), which is an inspection chart for adjustment, is performed and a provisional adjustment for the adjustment item is performed based on the printed image obtained by the adjustment printing and a confirmation process in which printing a confirmation chart (hereinafter referred to as “confirmation printing”), which is an inspection chart for confirmation, is performed and a validity of the provisional adjustment is verified based on the printed image obtained by the confirmation printing. When the adjustment chart and the confirmation chart are not distinguished, these are collectively referred to as an “inspection chart”. An adjustment chart printed on the front surface of the print paper PA is referred to as a “front surface adjustment chart”, an adjustment chart printed on the back surface of the print paper PA is referred to as a “back surface adjustment chart”, a confirmation chart printed on the front surface of the print paper PA is referred to as a “front surface confirmation chart”, and a confirmation chart printed on the back surface of the print paper PA is referred to as a “back surface confirmation chart”.

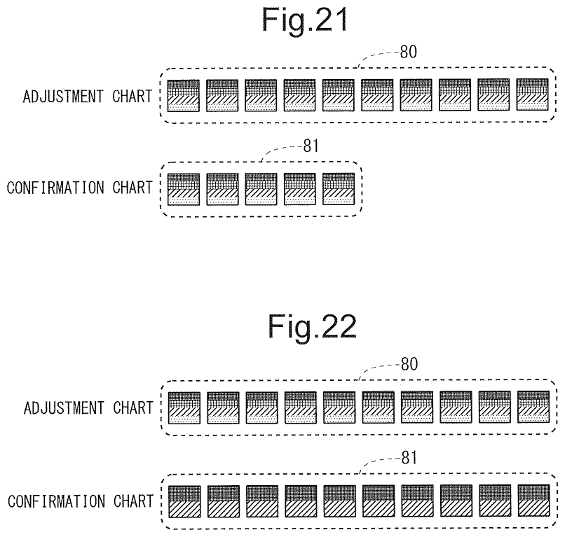

Here, the adjustment chart and the confirmation chart will be explained. The adjustment chart is a chart heretofore used to perform an adjustment for each adjustment item. The confirmation chart is a simpler chart compared to the adjustment chart. However, as for the modification described later, the same chart as the adjustment chart is also used as the confirmation chart. For each adjustment item, in general, each of the adjustment chart and the confirmation chart includes a plurality of sheets. Examples in which the confirmation chart is configured to be a simpler chart compared to the adjustment chart include the following three specific examples. In the first specific example, as shown in FIG. 21, the number of sheets constituting the confirmation chart 81 is fewer than the number of sheets constituting the adjustment chart 80. In the example shown in FIG. 21, the adjustment chart 80 is constituted by ten sheets, whereas the confirmation chart 81 is constituted by five sheets. In the second specific example, as shown in FIG. 22, although the number of sheets constituting the adjustment chart 80 is same as the number of sheets constituting the confirmation chart 81, an image contained in each sheet constituting the confirmation chart 81 is a simpler image than that contained in each sheet constituting the adjustment chart 80. For example, each sheet constituting the adjustment chart 80 contains an image including 10-level density range, whereas each sheet constituting the confirmation chart 81 contains an image including a 5-level density range. In the third specific example, the number of sheets constituting the confirmation chart 81 is fewer than the number of sheets constituting the adjustment chart 80 and an image contained in each sheet constituting the confirmation chart 81 is a simpler image than that contained in each sheet constituting the adjustment chart 80.

From the above, in the present embodiment, at least either one of the number of sheets and an image included in the sheets is different between the front surface inspection chart and the front surface confirmation chart which are corresponding to each of the plurality of adjustment items, and at least either one of the number of sheets and an image included in the sheets is different between the back surface inspection chart and the back surface confirmation chart which are corresponding to each of the plurality of adjustment items.

The overall configuration of the printing system (cf. FIG. 1), the configuration of the inkjet printing apparatus 10 (cf. FIG. 2), the configuration of the print head 24 (cf. FIG. 3), the hardware configuration of the print controller 100 (cf. FIG. 4), and the schematic functional configuration of the control unit 150 (cf. FIG. 6) are the same as in the above-described first embodiment. However, the adjustment item setting screen displayed on the display unit 123 by the adjustment item setting unit 158 is different from that displayed in the above-described first embodiment. Therefore, two examples of the adjustment item setting screen in the present embodiment will be explained.

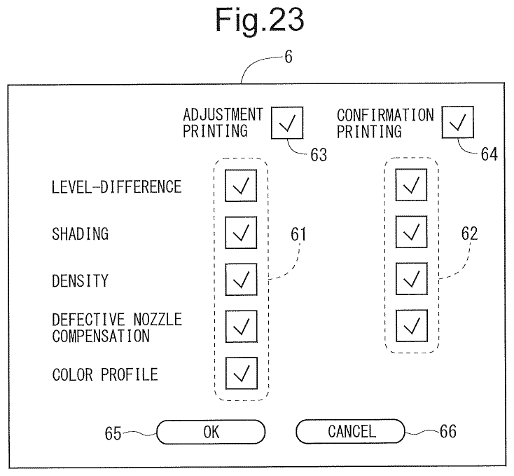

FIG. 23 is a diagram showing a first example of the adjustment item setting screen 6 in the present embodiment. It should be noted that the adjustment item setting screen 6 is prepared both for the front surface and the back surface. The adjustment item setting screen 6 shown in FIG. 23 includes a first checkbox group 61 consisting of five checkboxes provided to correspond one-to-one to five items (four adjustment items and color profile creation), a second checkbox group 62 consisting of four checkboxes provided to correspond one-to-one to four items, a checkbox 63, a checkbox 64, an OK button 65, and a cancel button 66.

The first checkbox group 61 is used to set whether to perform the provisional adjustment process for each adjustment item in addition to whether to perform the color profile creation process. The second checkbox group 62 is used to set whether to perform the confirmation process for each adjustment item. When the checkbox 63 transitions from an unchecked state to a checked state, all checkboxes included in the first checkbox group 61 become checked state. When the checkbox 63 transitions from the checked state to the unchecked state, all checkboxes included in the first checkbox group 61 become unchecked state. When the checkbox 64 transitions from the unchecked state to the checked state, all checkboxes included in the second checkbox group 62 become checked state. When the checkbox 64 transitions from the checked state to the unchecked state, all checkboxes included in the second checkbox group 62 become unchecked state. When the OK button 65 is pressed, settings set using the adjustment item setting screen 6 are saved. When the cancel button 66 is pressed, settings set using the adjustment item setting screen 6 are discarded, and the previous settings are maintained. Preferably, the adjustment item setting screen 6 is configured to be able to make setting in which the confirmation process is performed only for an adjustment item for which setting to perform the provisional adjustment process is made.

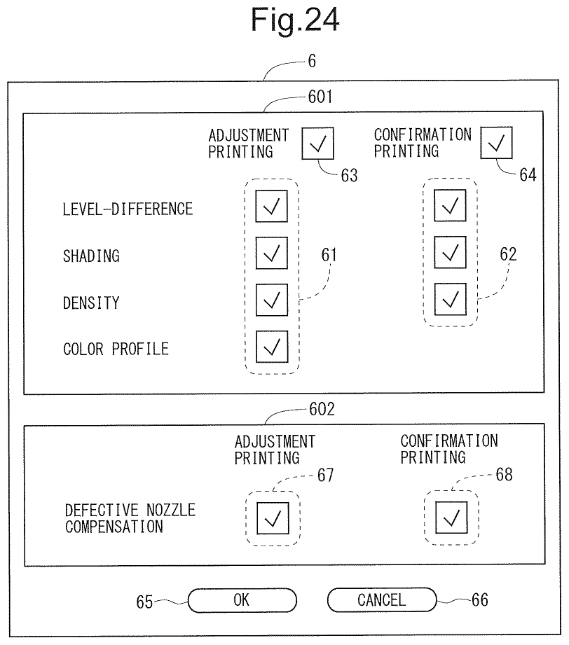

FIG. 24 is a diagram showing a second example of the adjustment item setting screen 6. Except for the region where the OK button 65 and the cancel button 66 are located, the adjustment item setting screen 6 shown in FIG. 24 is divided into a first region 601 for settings related to the level-difference adjustment, the shading adjustment, the density adjustment, and the color profile creation, and a second region 602 for settings related to the defective nozzle compensation. The first checkbox group 61, the second checkbox group 62, the checkbox 63, and the checkbox 64 are included in the first region 601, and these are the same as those in the first example (cf. FIG. 23). A checkbox 67 for setting whether to perform the provisional adjustment process for the defective nozzle compensation and a checkbox 68 for setting whether to perform the confirmation process for the defective nozzle compensation are included in the second region 602. Since the defective nozzle compensation may be performed less frequently than other adjustment items, the configuration shown in FIG. 24 may be adopted as the configuration of the adjustment item setting screen 6 for the convenience of the operator's operation.

### <3.2 Batch Adjustment Process>

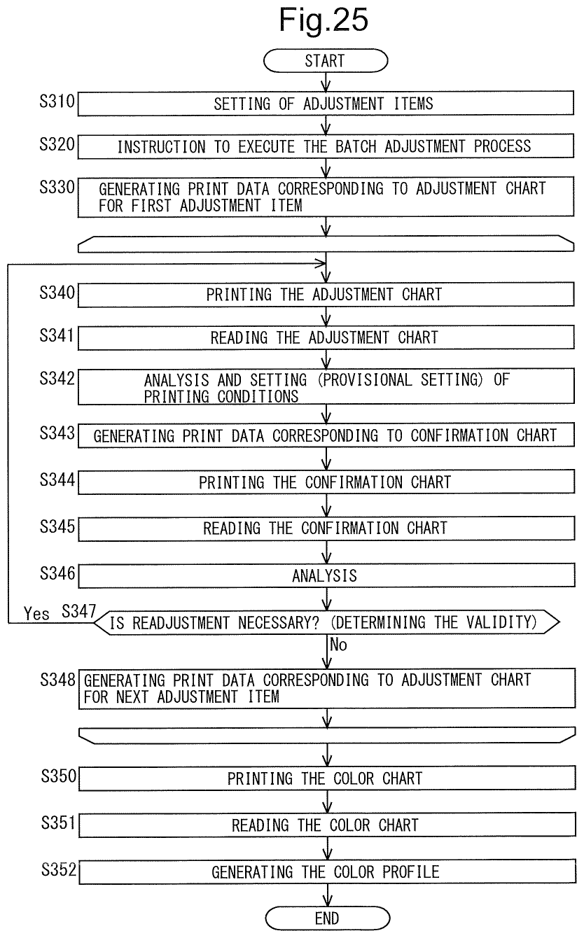

Next, the flow of the batch adjustment process (the adjustment method) in the present embodiment will be described with reference to the flowchart shown in FIG. 25. Steps S310 to S320 are the same as the steps S110 to S120 in FIG. 9. In step S330, the front surface adjustment print data that is print data corresponding to the front surface adjustment chart for the first adjustment item and the back surface adjustment print data that is print data corresponding to the back surface adjustment chart for the first adjustment item are generated as the adjustment process print data PD.

After generating the adjustment process print data PD, the processes of steps S340 to S348 described below are repeated the number of times equal to the number of adjustment items for which adjustment processes are performed. However, for adjustment items for which setting to perform only the provisional adjustment process is made in the step S310, the processes of steps S343 to S347 are not performed.

Steps S340 to S341 are the same as the steps S140 to S141 in FIG. 9. However, the inspection chart to be targeted for printing in the step S340 and for reading in the step S341 is the above-described adjustment chart. In step S342, as in the step S142 in FIG. 9, analysis of data obtained by the reading process and setting of printing conditions are performed. However, this setting of the printing conditions is provisional setting, and when a determination is made that readjustment is necessary in step S347 described below, the setting of the printing conditions is performed again.

After the setting (provisional setting) of the printing conditions are performed, the front surface confirmation print data that is print data corresponding to the front surface confirmation chart for the processing-target adjustment item and the back surface confirmation print data that is print data corresponding to the back surface confirmation chart for the processing-target adjustment item are generated as the adjustment process print data PD (S343). Specifically, the adjustment process print data generation unit 157 (cf. FIG. 6) generates the front surface confirmation print data using the data stored in the auxiliary storage device 121, based on the conveyance speed, the inter-heads distance, a distance from the front surface print head 24a to the front surface reader, and a product of the number of sheets and a sheet length for the front surface confirmation chart corresponding to the processing-target adjustment item, and generates the back surface confirmation print data using the data stored in the auxiliary storage device 121, based on the conveyance speed, the inter-heads distance, a distance from the back surface print head 24b to the back surface reader, and a product of the number of sheets and a sheet length for the back surface confirmation chart corresponding to the processing-target adjustment item.

In step S344, the confirmation chart is printed. Specifically, a front surface confirmation printing process in which the front surface print head 24a prints the front surface confirmation chart corresponding to the processing-target adjustment item and a back surface confirmation printing process in which the back surface print head 24b prints the back surface confirmation chart corresponding to the processing-target adjustment item are performed. It should be noted that the front surface confirmation printing process and the back surface confirmation printing process are collectively referred to as “confirmation printing process”.

In step S345, the printed image of the confirmation chart is read. Specifically, a front surface confirmation reading process in which the front surface imaging device 26a or the front surface colorimeter 27a reads the printed image of the front surface confirmation chart and a back surface confirmation reading process in which the back surface imaging device 26b or the back surface colorimeter 27b reads the printed image of the back surface confirmation chart are performed. It should be noted that the front surface confirmation reading process and the back surface confirmation reading process are collectively referred to as “confirmation reading process”.

In step S346, analysis of data obtained by the confirmation reading process is performed. Specifically, first, for each of the front surface and the back surface, adjustment data related to the adjustment for the processing-target adjustment item is obtained by analyzing data (front surface confirmation read data, back surface confirmation read data) that is obtained by the confirmation reading process. Then, for each of the front surface and the back surface, parameter values are calculated based on the adjustment data.

Thereafter, for each of the front surface and the back surface, the printing condition setting unit 151 determines the validity of the printing conditions provisionally set in the step S342 (that is, determines whether readjustment is necessary) (step S347). In the step S347, for example, when a value of the adjustment data obtained by the process of the step S346 is equal to or less than a predetermined reference value, it is determined that the provisionally set printing conditions are valid. When it is determined, in the step S347, that the provisionally set printing conditions are invalid for at least one of the front surface and the back surface, the process returns to the step S340. When it is determined, in the step S347, that the provisionally set printing conditions are valid for both the front surface and the back surface, the process proceeds to step S348. It should be noted that a process for determining the validity of the printing conditions for the front surface is referred to as a “front surface validity determination process”, and a process for determining the validity of the printing conditions for the back surface is referred to as a “back surface validity determination process”. The front surface validity determination process and the back surface validity determination process are collectively referred to as a “validity determination process”.

In step S348, as in the step S330, the front surface adjustment print data corresponding to the front surface adjustment chart for next adjustment item and the back surface adjustment print data corresponding to the back surface adjustment chart for next adjustment item are generated as the adjustment process print data PD.

Although the explanation is omitted in FIG. 25, after generating the print data corresponding to the adjustment chart and after generating the print data corresponding to the confirmation chart, the front surface print head 24a is maintained in a standby state until the printable region (the region where the adjustment chart or the confirmation chart should be printed) on the front surface of the print paper PA reaches the position of the front surface print head 24a, and the back surface print head 24b is maintained in a standby state until the printable region on the back surface of the print paper PA reaches the position of the back surface print head 24b.

Steps S350 to S352 are the same as the steps S150 to S152 in FIG. 9.

As above, in the present embodiment, for each adjustment item for which setting to perform the confirmation process (processes of the steps S343 to S347) is made, the confirmation process is performed after the provisional adjustment process (processes of the steps S340 to S342), and the provisional adjustment process and the confirmation process are repeated until it is determined in the confirmation process that the printing conditions set in the provisional adjustment process are valid for both the front surface and the back surface. Further, regarding the preceding adjustment item and the subsequent adjustment item that are two adjustment items for which adjustment processes are performed consecutively in the batch adjustment process, the front surface printing process for the subsequent adjustment item is performed after the front surface validity determination process for the preceding adjustment item is ended, and the back surface printing process for the subsequent adjustment item is performed after the back surface validity determination process for the preceding adjustment item is ended.

By the way, for example, in a case in which a serious defect occurs in the inkjet head 241, the adjustment may not be performed appropriately (the parameter values may not be obtained appropriately) even when the processes of the steps S340 to S348 described above are repeated. Therefore, when the number of times the provisionally set printing conditions are determined to be invalid in the step S347 for at least one of the front surface and the back surface in the adjustment process for each adjustment item exceeds a predetermined number, an error message is displayed on the display unit 123, and the batch adjustment process ends. It should be noted that the predetermined number may differ for each adjustment item.

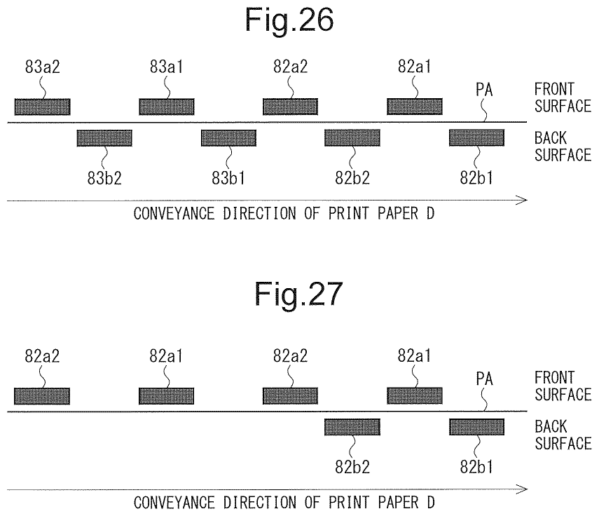

In the present embodiment, in a case in which readjustment is not performed for both the level-difference adjustment and the shading adjustment, a state of the print paper PA at the end time point of the shading adjustment (cf. FIG. 5) is a state as schematically shown in FIG. 26, for example. Regarding FIG. 26, the back surface adjustment chart corresponding to the level-difference adjustment is denoted by reference sign 82b1, the front surface adjustment chart corresponding to the level-difference adjustment is denoted by reference sign 82a1, the back surface confirmation chart corresponding to the level-difference adjustment is denoted by reference sign 82b2, the front surface confirmation chart corresponding to the level-difference adjustment is denoted by reference sign 82a2, the back surface adjustment chart corresponding to the shading adjustment is denoted by reference sign 83b1, the front surface adjustment chart corresponding to the shading adjustment is denoted by reference sign 83a1, the back surface confirmation chart corresponding to the shading adjustment is denoted by reference sign 83b2, and the front surface confirmation chart corresponding to the shading adjustment is denoted by reference sign 83a2. In this manner, the inspection charts (the adjustment charts or the confirmation charts) are printed alternately on the front surface and the back surface regarding the conveyance direction D of the print paper PA.

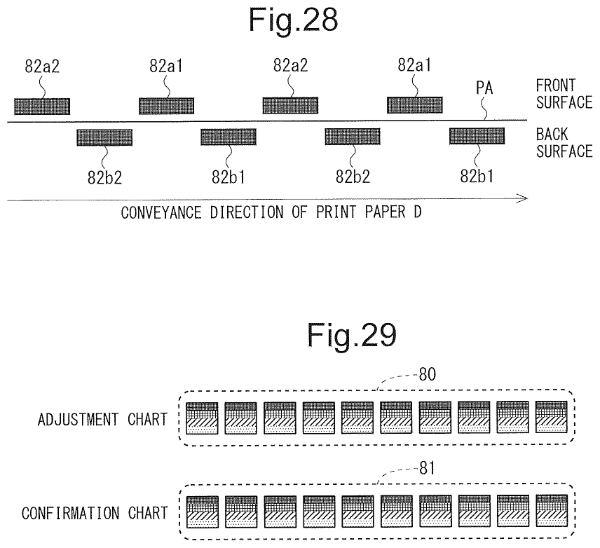

In a case in which readjustment is determined, in the step S347 described above, to be necessary for both the front surface and the back surface, the provisional adjustment process and the confirmation process should be re-performed for both the front surface and the back surface. In a case in which readjustment is determined, in the step S347 described above, to be necessary only for one of the front surface and the back surface, the provisional adjustment process and the confirmation process may be re-performed for only a surface for which readjustment is necessary, and the provisional adjustment process and the confirmation process may be re-performed for both the front surface and the back surface. Regarding this, for example, in a case in which readjustment is determined, in the step S347 described above, to be necessary for the front surface in regard to the level-difference adjustment, when the provisional adjustment process and the confirmation process are re-performed for only the front surface, a state of the print paper PA after re-performing them is a state as schematically shown in FIG. 27. In this example, the back surface adjustment chart 82b1 corresponding to the level-difference adjustment and the back surface confirmation chart 82b2 corresponding to the level-difference adjustment are each printed once, whereas the front surface adjustment chart 82a1 corresponding to the level-difference adjustment and the front surface confirmation chart 82a2 corresponding to the level-difference adjustment are each printed twice. In the same case, when the provisional adjustment process and the confirmation process are re-performed for both the front surface and the back surface, a state of the print paper PA after re-performing them is a state as schematically shown in FIG. 28. In this example, the back surface adjustment chart 82b1 corresponding to the level-difference adjustment, the back surface confirmation chart 82b2 corresponding to the level-difference adjustment, the front surface adjustment chart 82a1 corresponding to the level-difference adjustment, and the front surface confirmation chart 82a2 corresponding to the level-difference adjustment are each printed twice.

### <3.3 Effects>

According to the present embodiment, regarding the batch adjustment process, in the adjustment process for each of the plurality of adjustment items, after the printing conditions are provisionally set based on the read data of the printed image of the adjustment chart, the confirmation chart is printed in a state in which the printing conditions are provisionally set. Then, for each of the front surface and the back surface, determining (confirming) the validity of the provisionally set printing conditions is performed based on the read data of the printed image of the confirmation chart. Thus, for each of the front surface and the back surfaces, it is possible to prevent the adjustment process for the subsequent adjustment item from being performed in a state in which the adjustment process for the preceding adjustment item is not appropriately performed. From the above, in addition to obtaining the same effects as the above-described first embodiment, the effects of suppressing the occurrence of serious turn back of the processes can be obtained.

### <3.4 Modification>

In the third embodiment, the confirmation chart is different from the adjustment chart. Specifically, the confirmation chart is a simpler chart compared to the adjustment chart. In contrast, in the present modification, the same chart as the adjustment chart is also used as the confirmation chart. That is, in the adjustment process for each of the plurality of adjustment items, the adjustment chart 80 and the confirmation chart 81 are identical as shown in FIG. 29. More specifically, the front surface inspection chart and the front surface confirmation chart which are corresponding to each of the plurality of adjustment items are identical, and the back surface inspection chart and the back surface confirmation chart which are corresponding to each of the plurality of adjustment items are identical.

In the third embodiment, since the confirmation chart is a simpler chart compared to the adjustment chart, setting (provisional setting) of the printing conditions cannot be performed based on the read data for the confirmation chart. Therefore, in a case in which readjustment is determined, in the step S347 in FIG. 25, to be necessary for at least one of the front surface and the back surface, the adjustment processes should be re-performed from the process of the step S340 (the process of printing the adjustment chart). In contrast, in the present modification, since the confirmation chart is the same as the adjustment chart (the same chart as the adjustment chart is also used as the confirmation chart), setting (provisional setting) of the printing conditions can be performed based on the read data for the confirmation chart. Accordingly, in a case in which readjustment is determined, in the step S347, to be necessary, there is no need to perform the process of printing the adjustment chart again for newly setting of the printing conditions.

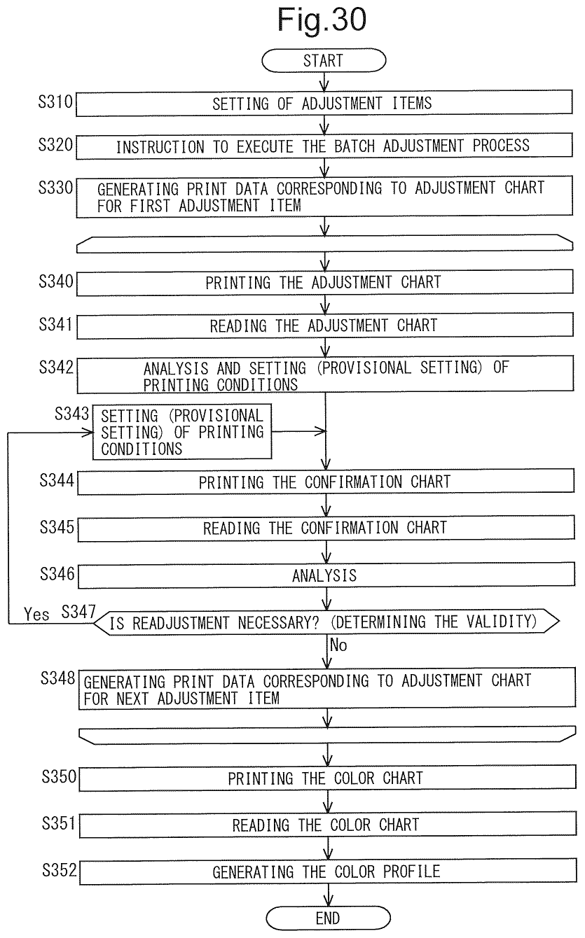

FIG. 30 is a flowchart showing a flow of the batch adjustment process (that is, a f flowchart for explaining adjustment method) in the modification. In the modification, when a determination is made that readjustment is necessary in the step S347, the process proceeds to step S349. In step S349, setting (provisional setting) of the printing conditions is performed. Thereafter, the process returns to the step S344. As above, in a case in which readjustment is determined to be necessary for at least one of the front surface and the back surface based on the read data for the confirmation chart, at least for a surface for which readjustment is necessary, the printing conditions are provisionally set based on the read data and the processes after the confirmation printing process are re-performed.

Thus, in the present modification, regarding the front surface adjustment process, when the printing conditions set by the front surface printing condition setting process are determined to be invalid in the front surface validity determination process for the processing-target adjustment item, after the printing conditions related to printing on the front surface of the print paper PA are set based on data obtained by the front surface confirmation reading process (the front surface confirmation read data), the front surface adjustment process for the processing-target adjustment item is re-performed from the front surface confirmation printing process. The same applies to the back surface adjustment process.

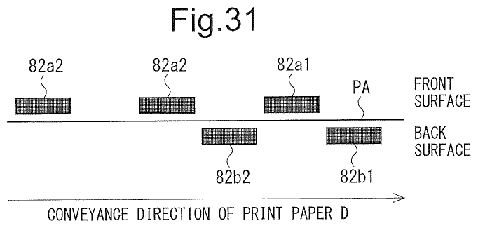

By the way, for example, in a case in which readjustment is determined, in the step S347 described above, to be necessary for the front surface regarding the level-difference adjustment, when processes after confirmation printing process are re-performed for only the front surface, a state of the print paper PA after re-performing them is a state as schematically shown in FIG. 31. Regarding a similar case, in the third embodiment, the front surface adjustment chart 82a1 corresponding to the level-difference adjustment is printed twice (cf. FIG. 27). In contrast, in the present modification, the front surface adjustment chart 82a1 corresponding to the level-difference adjustment is printed once. Although the front surface adjustment chart 82a1 and the front surface confirmation chart 82a2 are denoted by different reference signs, these charts are identical in the present modification.

According to the present modification, in a case in which the provisionally set printing conditions are determined to be invalid in the validity determination process, resetting of the printing conditions can be promptly performed based on the read data obtained at the last minute for the confirmation chart. Accordingly, turn back of the processes when readjustment is necessary can be reduced compared to that in the third embodiment.

### 4. Others

The present invention is not limited to each of the above embodiments (including the modification), and various modifications can be made without departing from the gist of the present invention. For example, although the configuration of the inkjet printing apparatus 10 that performs color printing has been exemplified in the above embodiments, the present invention can also be applied to a case in which an inkjet printing apparatus that performs monochrome printing is employed. Moreover, although the configuration of the inkjet printing apparatus 10 using aqueous ink has been exemplified in the above embodiments, the present invention can also be applied to a case in which an inkjet printing apparatus using ultraviolet (UV) ink (ultraviolet curing ink) such as an inkjet printing apparatus for label printing is employed. In this case, an ultraviolet irradiation mechanism for curing the UV ink on the print paper PA by ultraviolet irradiation is provided inside the printing mechanism 20a and 20b (cf. FIG. 2), instead of the drying mechanism 25a and 25b. Further, the base material on which printing is performed is not limited to a paper material print medium, and may be a transparent, translucent, or opaque polyethylene terephthalate (PET) film.

Furthermore, although the level-difference adjustment, the shading adjustment, the density adjustment, the defective nozzle compensation, and the color profile creation process are performed by the batch adjustment process in the above embodiments, adjustment items for which the adjustment processes are performed in the batch adjustment process are not specifically limited.

What is claimed is:

1. A printing apparatus capable of printing on both a front surface of a base material having a long belt shape and a back surface of the base material, the printing apparatus comprising:
a conveyance mechanism configured to convey the base material in a predetermined conveyance direction;
a front surface print head configured to perform printing on the front surface of the base material by ejecting ink;
a front surface reader configured to read a printed image obtained by printing by the front surface print head;
a back surface print head configured to perform printing on the back surface of the base material by ejecting ink;
a back surface reader configured to read a printed image obtained by printing by the back surface print head; and
a controller configured to control operations of the conveyance mechanism, the front surface print head, the front surface reader, the back surface print head, and the back surface reader, wherein
a batch adjustment process of performing adjustment processes for a plurality of adjustment items related to printing based on one instruction from an outside is executable,
the batch adjustment process includes
a front surface printing process in which the front surface print head prints a front surface inspection chart corresponding to a processing-target adjustment item,
a front surface reading process in which the front surface reader reads a printed image of the front surface inspection chart,
a front surface printing condition setting process in which the controller sets a printing condition related to printing on the front surface of the base material based on front surface read data obtained by the front surface reading process,
a back surface printing process in which the back surface print head prints a back surface inspection chart corresponding to the processing-target adjustment item,
a back surface reading process in which the back surface reader reads a printed image of the back surface inspection chart, and
a back surface printing condition setting process in which the controller sets a printing condition related to printing on the back surface of the base material based on back surface read data obtained by the back surface reading process,
the front surface printing process and the back surface printing process are performed in parallel, and
regarding a preceding adjustment item and a subsequent adjustment item that are two adjustment items for which adjustment processes are performed consecutively in the batch adjustment process,
the front surface printing process for the subsequent adjustment item begins in such a way that a distance from an end position of the front surface inspection chart corresponding to the preceding adjustment item to a surface inspection chart start position of the front corresponding to the subsequent adjustment item is equal to or larger than a sum of a distance the base material is conveyed during a period from an end time point of the front surface reading process for the preceding adjustment item to an end time point of the front surface printing condition setting process for the preceding adjustment item and a distance from the front surface print head to the front surface reader, and
the back surface printing process for the subsequent adjustment item begins in such a way that a distance from an end position of the back surface inspection chart corresponding to the preceding adjustment item to a start position of the back surface inspection chart corresponding to the subsequent adjustment item is equal to or larger than a sum of a distance the base material is conveyed during a period from an end time point of the back surface reading process for the preceding adjustment item to an end time point of the back surface printing condition setting process for the preceding adjustment item and a distance from the back surface print head to the back surface reader.

2. The printing apparatus according to claim 1, wherein
the front surface printing process for the subsequent adjustment item begins in such a way that the distance from the end position of the front surface inspection chart corresponding to the preceding adjustment item to the start position of the front surface inspection chart corresponding to the subsequent adjustment item is equal to or larger than a distance from the front surface print head to the back surface print head,
the back surface printing process for the subsequent adjustment item begins in such a way that the distance from the end position of the back surface inspection chart corresponding to the preceding adjustment item to the start position of the back surface inspection chart corresponding to the subsequent adjustment item is equal to or larger than the distance from the front surface print head to the back surface print head,
print length of the front surface inspection chart printed continuously at one process in the front surface printing process is equal to or less than the distance from the front surface print head to the back surface print head, and
print length of the back surface inspection chart printed continuously at one process in the back surface printing process is equal to or less than the distance from the front surface print head to the back surface print head.

3. The printing apparatus according to claim 2, wherein
the front surface printing process and the back surface printing process begin at same timing.

4. The printing apparatus according to claim 2, wherein
the print length of the front surface inspection chart printed continuously at one process in the front surface printing process is equal to the distance from the front surface print head to the back surface print head, and
the print length of the back surface inspection chart printed continuously at one process in the back surface printing process is equal to the distance from the front surface print head to the back surface print head.

5. The printing apparatus according to claim 1, wherein
the front surface printing process and the back surface printing process begin at same timing.

6. The printing apparatus according to claim 1, wherein
the back surface print head is positioned downstream of the front surface print head in the predetermined conveyance direction, and
the back surface printing process for the subsequent adjustment item begins in such a way that the start position of the back surface inspection chart corresponding to the subsequent adjustment item is a position immediately following the end position of the front surface inspection chart corresponding to the preceding adjustment item.

7. The printing apparatus according to claim 1, wherein
the front surface inspection chart corresponding to each of the plurality of adjustment items includes a plurality of sheets,
the back surface inspection chart corresponding to each of the plurality of adjustment items includes plurality of sheets,
when a product of the number of sheets and a sheet length for the front surface inspection chart corresponding to the processing-target adjustment item is longer than a distance from the front surface print head to the back surface print head, the front surface printing process is performed in a plurality of times such that print length of the front surface inspection chart printed continuously at one process in the front surface printing process is equal to or less than the distance from the front surface print head to the back surface print head, and
when a product of the number of sheets and a sheet length for the back surface inspection chart corresponding to the processing-target adjustment item is longer than the distance from the front surface print head to the back surface print head, the back surface printing process is performed in a plurality of times such that print length of the back surface inspection chart printed continuously at one process in the back surface printing process is equal to or less than the distance from the front surface print head to the back surface print head.

8. The printing apparatus according to claim 1, wherein
the back surface print head is positioned downstream of the front surface print head in the predetermined conveyance direction, and
the front surface printing process and the back surface printing process are performed in such a way that, regarding all combinations of the two adjustment items based on the plurality of adjustment items, the front surface inspection chart corresponding to the preceding adjustment item is printed on a region, on the front surface, between the end position of the back surface inspection chart corresponding to the preceding adjustment item and the start position of the back surface inspection chart corresponding to the subsequent adjustment item, and the back surface inspection chart corresponding to the subsequent adjustment item is printed on a region, on the back surface, between the end position of the front surface inspection chart corresponding to the preceding adjustment item and the start position of the front surface inspection chart corresponding to the subsequent adjustment item.

9. The printing apparatus according to claim 1, wherein
the front surface inspection chart corresponding to each of the plurality of adjustment items includes a plurality of sheets,
the back surface inspection chart corresponding to each of the plurality of adjustment items includes a plurality of sheets,
after receiving an instruction to execute the batch adjustment process and before beginning of an adjustment process for a first adjustment item, the controller generates front surface print data corresponding to an overall chart to be printed on the front surface of the base material and back surface print data corresponding to an overall chart to be printed on the back surface of the base material based on a conveyance speed at which the conveyance mechanism conveys the base material, a distance from the front surface print head to the back surface print head, the distance from the front surface print head to the front surface reader, the distance from the back surface print head to the back surface reader, a product of the number of sheets and a sheet length for the front surface inspection chart corresponding to each of the plurality of adjustment items, and a product of the number of sheets and a sheet length for the back surface inspection chart corresponding to each of the plurality of adjustment items, and
in the batch adjustment process, the front surface printing process is performed based on the front surface print data and the back surface printing process is performed based on the back surface print data.

10. The printing apparatus according to claim 1, wherein
the front surface inspection chart corresponding to each of the plurality of adjustment items includes a plurality of sheets,
the back surface inspection chart corresponding to each of the plurality of adjustment items includes a plurality of sheets,
after the front surface printing condition setting process for the preceding adjustment item is ended, the controller generates front surface print data corresponding to a chart to be printed on the front surface of the base material in the front surface printing process for the subsequent adjustment item, based on a conveyance speed at which the conveyance mechanism conveys the base material, a distance from the front surface print head to the back surface print head, the distance from the front surface print head to the front surface reader, and a product of the number of sheets and a sheet length for the front surface inspection chart corresponding to the subsequent adjustment item,
after the back surface printing condition setting process for the preceding adjustment item is ended, the controller generates back surface print data corresponding to a chart to be printed on the back surface of the base material in the back surface printing process for the subsequent adjustment item, based on the conveyance speed, the distance from the front surface print head to the back surface print head, the distance from the back surface print head to the back surface reader, and a product of the number of sheets and a sheet length for the back surface inspection chart corresponding to the subsequent adjustment item, and
the front surface printing process for the subsequent adjustment item based on the front surface print data is performed along with the back surface printing process for the subsequent adjustment item based on the back surface print data.

11. The printing apparatus according to claim 1, wherein
the batch adjustment process further includes
a front surface confirmation printing process in which the front surface print head prints a front surface confirmation chart for confirming a validity of the printing condition set by the front surface printing condition setting process,
a front surface confirmation reading process in which the front surface reader reads a printed image of the front surface confirmation chart,
a front surface validity determination process for determining the validity of the printing condition set by the front surface printing condition setting process, based on front surface confirmation read data obtained by the front surface confirmation reading process,
a back surface confirmation printing process in which the back surface print head prints a back surface confirmation chart for confirming a validity of the printing condition set by the back surface printing condition setting process,
a back surface confirmation reading process in which the back surface reader reads a printed image of the back surface confirmation chart, and
a back surface validity determination process for determining the validity of the printing condition set by the back surface printing condition setting process, based on back surface confirmation read data obtained by the back surface confirmation reading process.

12. The printing apparatus according to claim 11, wherein
the front surface inspection chart corresponding to each of the plurality of adjustment items includes a plurality of sheets,
the front surface confirmation chart corresponding to each of the plurality of adjustment items includes a plurality of sheets,
the back surface inspection chart corresponding to each of the plurality of adjustment items includes a plurality of sheets,
the back surface confirmation chart corresponding to each of the plurality of adjustment items includes plurality of sheets,
after the front surface printing condition setting process for the preceding adjustment item is ended, the controller generates front surface confirmation print data corresponding to a chart to be printed on the front surface of the base material in the front surface confirmation printing process for the preceding adjustment item, based on a conveyance speed at which the conveyance mechanism conveys the base material, a distance from the front surface print head to the back surface print head, the distance from the front surface print head to the front surface reader, and a product of the number of sheets and a sheet length for the front surface confirmation chart corresponding to the preceding adjustment item,
after the back surface printing condition setting process for the preceding adjustment item is ended, the controller generates back surface confirmation print data corresponding to a chart to be printed on the back surface of the base material in the back surface confirmation printing process for the preceding adjustment item, based on the conveyance speed, the distance from the front surface print head to the back surface print head, the distance from the back surface print head to the back surface reader, and a product of the number of sheets and a sheet length for the back surface confirmation chart corresponding to the preceding adjustment item,
the front surface confirmation printing process for the preceding adjustment item based on the front surface confirmation print data is performed along with the back surface confirmation printing process for the preceding adjustment item based on the back surface confirmation print data,
after the front surface validity determination process for the preceding adjustment item is ended, the controller generates front surface adjustment print data corresponding to a chart to be printed on the front surface of the base material in the front surface printing process for the subsequent adjustment item, based on the conveyance speed, the distance from the front surface print head to the back surface print head, the distance from the front surface print head to the front surface reader, and a product of the number of sheets and a sheet length for the front surface inspection chart corresponding to the subsequent adjustment item,
after the back surface validity determination process for the preceding adjustment item is ended, the controller generates back surface adjustment print data corresponding to a chart to be printed on the back surface of the base material in the back surface printing process for the subsequent adjustment item, based on the conveyance speed, the distance from the front surface print head to the back surface print head, the distance from the back surface print head to the back surface reader, and a product of the number of sheets and a sheet length for the back surface inspection chart corresponding to the subsequent adjustment item, and
the front surface printing process for the subsequent adjustment item based on the front surface adjustment print data is performed along with the back surface printing process for the subsequent adjustment item based on the back surface adjustment print data.

13. The printing apparatus according to claim 11, wherein
the front surface inspection chart and the front surface confirmation chart corresponding to each of the plurality of adjustment items are identical, and
the back surface inspection chart and the back surface confirmation chart corresponding to each of the plurality of adjustment items are identical.

14. The printing apparatus according to claim 13, wherein
regarding a front surface adjustment process including the front surface printing process, the front surface reading process, the front surface printing condition setting process, the front surface confirmation printing process, the front surface confirmation reading process, and the front surface validity determination process, when the printing condition set by the front surface printing condition setting process is determined to be invalid in the front surface validity determination process for the processing-target adjustment item, after the printing condition related to printing on the front surface of the base material is set based on the front surface confirmation read data, the front surface adjustment process for the processing-target adjustment item is re-performed from the front surface confirmation printing process, and
regarding a back surface adjustment process including the back surface printing process, the back surface reading process, the back surface printing condition setting process, the back surface confirmation printing process, the back surface confirmation reading process, and the back surface validity determination process, when the printing condition set by the back surface printing condition setting process is determined to be invalid in the back surface validity determination process for the processing-target adjustment item, after the printing condition related to printing on the back surface of the base material is set based on the back surface confirmation read data, the back surface adjustment process for the processing-target adjustment item is re-performed from the back surface confirmation printing process.

15. The printing apparatus according to claim 11, wherein
the front surface inspection chart corresponding to each of the plurality of adjustment items includes a plurality of sheets,
the front surface confirmation chart corresponding to each of the plurality of adjustment items includes a plurality of sheets,
the back surface inspection chart corresponding to each of the plurality of adjustment items includes a plurality of sheets,
the back surface confirmation chart corresponding to each of the plurality of adjustment items includes a plurality of sheets,
at least either one of the number of sheets and an image included in the sheets is different between the front surface inspection chart and the front surface confirmation chart corresponding to each of the plurality of adjustment items, and
at least either one of the number of sheets and an image included in the sheets is different between the back surface inspection chart and the back surface confirmation chart corresponding to each of the plurality of adjustment items.

16. The printing apparatus according to claim 15, wherein
regarding a front surface adjustment process including the front surface printing process, the front surface reading process, the front surface printing condition setting process, the front surface confirmation printing process, the front surface confirmation reading process, and the front surface validity determination process, when the printing condition set by the front surface printing condition setting process is determined to be invalid in the front surface validity determination process for the processing-target adjustment item, the front surface adjustment process for the processing-target adjustment item is re-performed from the front surface printing process, and
regarding a back surface adjustment process including the back surface printing process, the back surface reading process, the back surface printing condition setting process, the back surface confirmation printing process, the back surface confirmation reading process, and the back surface validity determination process, when the printing condition set by the back surface printing condition setting process is determined to be invalid in the back surface validity determination process for the processing-target adjustment item, the back surface adjustment process for the processing-target adjustment item is re-performed from the back surface printing process.

17. The printing apparatus according to claim 11, wherein
the front surface printing process for the subsequent adjustment item is performed after the front surface validity determination process for the preceding adjustment item is ended, and
the back surface printing process for the subsequent adjustment item is performed after the back surface validity determination process for the preceding adjustment item is ended.

18. The printing apparatus according to claim 1, further comprising a display, wherein
the display displays an adjustment item setting screen for externally setting whether to perform, for each of the plurality of adjustment items, each of the front surface adjustment process and the back surface adjustment process, the front surface adjustment process including the front surface printing process, the front surface reading process, and the front surface printing condition setting process, the back surface adjustment process including the back surface printing process, the back surface reading process, and the back surface printing condition setting process, and the batch adjustment process is executed in accordance with settings set by the adjustment item setting screen.

19. The printing apparatus according to claim 1, further comprising:
a first image sensor configured to capture the printed image obtained by printing by the front surface print head and a first colorimeter configured to perform colorimetry of the printed image obtained by printing by the front surface print head, as the front surface reader; and
a second image sensor configured to capture the printed image obtained by printing by the back surface print head and a second colorimeter configured to perform colorimetry of the printed image obtained by printing by the back surface print head, as the back surface reader, wherein
in the batch adjustment process, a level-difference adjustment, a shading adjustment, and a density adjustment are performed as adjustment processes for the plurality of adjustment items,
in the front surface reading process in each of the level-difference adjustment and the shading adjustment, the first image sensor captures the printed image of the front surface inspection chart corresponding to the processing-target adjustment item,
in the front surface reading process in the density adjustment, the first colorimeter performs colorimetry of the printed image of the front surface inspection chart corresponding to the processing-target adjustment item,
in the back surface reading process in each of the level-difference adjustment and the shading adjustment, the second image sensor captures the printed image of the back surface inspection chart corresponding to the processing-target adjustment item, and
in the back surface reading process in the density adjustment, the second colorimeter performs colorimetry of the printed image of the back surface inspection chart corresponding to the processing-target adjustment item.

20. An adjustment method for a printing apparatus capable of printing on both a front surface of a base material having a long belt shape and a back surface of the base material, the printing apparatus including
a conveyance mechanism configured to convey the base material in a predetermined conveyance direction;
a front surface print head configured to perform printing on the front surface of the base material by ejecting ink;
a front surface reader configured to read a printed image obtained by printing by the front surface print head;
a back surface print head configured to perform printing on the back surface of the base material by ejecting ink;
a back surface reader configured to read a printed image obtained by printing by the back surface print head; and
a controller configured to control operations of the conveyance mechanism, the front surface print head, the front surface reader, the back surface print head, and the back surface reader,
the adjustment method comprising:
issuing an instruction, by an operator, to the printing apparatus to execute a batch adjustment process of performing adjustment processes for a plurality of adjustment items related to printing; and
executing, by the printing apparatus, the batch adjustment process in accordance with the instruction, wherein
for each of the plurality of adjustment items, the batch adjustment process includes
an inspection chart printing process in which the front surface print head prints a front surface inspection chart corresponding to a processing-target adjustment item and the back surface print head prints a back surface inspection chart corresponding to the processing-target adjustment item, in parallel,
an inspection chart reading process in which the front surface reader reads a printed image of the front surface inspection chart to obtain front surface read data and the back surface reader reads a printed image of the back surface inspection chart to obtain back surface read data, in parallel, and
a printing condition setting process in which the controller sets a printing condition related to printing on the front surface of the base material based on the front surface read data and sets a printing condition related to printing on the back surface of the base material based on the back surface read data, and
regarding a preceding adjustment item and a subsequent adjustment item that are two adjustment items for which adjustment processes are performed consecutively in the batch adjustment process,
printing the front surface inspection chart corresponding to the subsequent adjustment item in the inspection chart printing process for the subsequent adjustment item begins in such a way that a distance from an end position of the front surface inspection chart corresponding to the preceding adjustment item to a start position of the front surface inspection chart corresponding to the subsequent adjustment item is equal to or larger than a sum of a distance the base material is conveyed during a period from an end time point of reading the printed image of the front surface inspection chart in the inspection chart reading process for the preceding adjustment item to an end time point of setting the printing condition related to printing on the front surface of the base material in the printing condition setting process for the preceding adjustment item and a distance from the front surface print head to the front surface reader, and
printing the back surface inspection chart corresponding to the subsequent adjustment item in the inspection chart printing process for the subsequent adjustment item begins in such a way that a distance from an end position of the back surface inspection chart corresponding to the preceding adjustment item to a start position of the back surface inspection chart corresponding to the subsequent adjustment item is equal to or larger than a sum of a distance the base material is conveyed during a period from an end time point of reading the printed image of the back surface inspection chart in the inspection chart reading process for the preceding adjustment item to an end time point of setting the printing condition related to printing on the back surface of the base material in the printing condition setting process for the preceding adjustment item and a distance from the back surface print head to the back surface reader.
